(19) United States
(12) Patent Application Publication
(10) Pub. No.: US 2024/0366029 A1
(43) Pub. Date: Nov. 7, 2024

(54) COOKING APPLIANCE

(71) Applicant: Newell Australia Pty Ltd, Scoresby, Victoria (AU)

(72) Inventors: Craig MACLAREN, NSW (AU); Ahmed RAFIQ, Kensington, New South Wales (AU); Mark Nathan SPAILE, Little Bay, New South Wales (AU); Wai Sum HO, Kowloon Bay, Kowloon (CN); Kwai Keung SIU, Kowloon Bay, Kowloon (CN)

(21) Appl. No.: 18/580,946

(22) PCT Filed: Jul. 18, 2022
(86) PCT No.: PCT/AU2022/050757

§ 371 Date: Jan. 19, 2024

(30) Foreign Application Priority Data
Jul. 19, 2021 (AU) 2021902211
Jul. 19, 2021 (AU) 2021902216

(51) Int. Cl. A47J 37/06

(52) U.S. Cl. CPC A47J 37/0611; A47J 2037/0617

(57) ABSTRACT

A cooking appliance (100) comprising: a lower cooking assembly (102) carrying a lower cooking plate (109); a handle (104) pivotally coupled to the lower cooking assembly (102) about a first pivot arrangement (170); an upper cooking assembly (102) pivotally coupled to the handle (104) about a second pivot arrangement (127, 128), the upper cooking assembly (101) carrying an upper cooking plate (107); and a locking assembly (105) configured to engage the first pivot arrangement (170), the locking assembly (105) movable between a locked configuration in which the locking assembly (105) is engaged with the first pivot arrangement (170) and an unlocked configuration in which the locking assembly (105) is disengaged from the first pivot arrangement (170). In the unlocked configuration, the handle (104) is able to rotate about the first pivot arrangement (170) to vary a position of the upper cooking assembly (101) with respect to the lower cooking assembly (102). In the locked configuration, rotation of the handle (104) about the first pivot arrangement (170) is restricted, thereby releasably retaining the upper cooking assembly (101) at one of a plurality of positions with respect to the lower cooking assembly (102).

### CROSS REFERENCE TO RELATED APPLICATIONS

This application claims priority to Australian Provisional Patent Application No 2021902216 filed 19 Jul. 2021 and Australian Provisional Patent Application No 2021902211 filed 19 Jul. 2021, the contents of both being incorporated herein by reference in their entirety.

### FIELD OF THE INVENTION

The present disclosure relates to a cooking appliance. In particular, the present disclosure relates to a cooking appliance having a locking assembly that allows an upper cooking plate of the cooking appliance to be releasably retained a plurality of distances from the lower cooking plate of the cooking appliance.

### BACKGROUND OF THE INVENTION

Cooking appliances having a lower cooking assembly and an upper cooking assembly are known. The upper and lower cooking assemblies of these known cooking appliances typically include an upper and lower cooking plate, respectively, between which food can be heated and/or cooked. Such known cooking appliances include electric sandwich presses and grills.

These known cooking appliances may in some cases have a strut mechanism to retain the upper cooking plate at a limited number of distinct positions above the lower cooking plate. However, the height of food placed on the lower cooking plate may be between two of the distinct positions. (i.e. a lower and upper position). In this case, a user may not use the retention mechanism and rest the upper cooking assembly on the food, which may undesirably compress the food. Alternatively, the user may use the retention mechanism to retain the upper cooking plate at the upper position. In this case, the upper cooking plate may not be in contact with the food, which not desirable as the top of the food may cook at a different rate compared to the bottom of the food that is in contact with the lower cooking plate.

### SUMMARY OF THE INVENTION

According to an aspect of the invention, there is provided a cooking appliance comprising: a lower cooking assembly carrying a lower cooking plate; a handle pivotally coupled to the lower cooking assembly about a first pivot arrangement; an upper cooking assembly pivotally coupled to the handle about a second pivot arrangement, the upper cooking assembly carrying an upper cooking plate; and a locking assembly configured to engage the first pivot arrangement, the locking assembly movable between a locked configuration in which the locking assembly is engaged with the first pivot arrangement and an unlocked configuration in which the locking assembly is disengaged from the first pivot arrangement, wherein: in the unlocked configuration, the handle is able to rotate about the first pivot arrangement to vary a position of the upper cooking assembly with respect to the lower cooking assembly; and in the locked configuration, rotation of the handle about the first pivot arrangement is restricted, thereby releasably retaining the upper cooking assembly at one of a plurality of positions with respect to the lower cooking assembly.

In an embodiment, the locking assembly has a first engagement element connected to the handle and a second engagement element; in the unlocked configuration, the first and second engagement elements are disengaged from each other, thereby allowing the handle to rotate about the first pivot arrangement; and in the locked configuration, the first and second engagement elements are engaged with each other, the engagement of the first and second engagement elements restricting rotation of the handle about the first pivot arrangement.

In an embodiment, the first pivot arrangement comprises a pivot connected to the lower cooking assembly and a pivot ring connected to the handle; the pivot ring is pivotally coupled to the pivot and configured to rotate about the pivot; and the first engagement element is disposed around the pivot ring.

In an embodiment, the pivot has a pivot shaft defining a pivot shaft axis; in response to moving the locking assembly from the locked configuration to the unlocked configuration, the second engagement element moves away from the first engagement element along the pivot shaft axis to disengage from the first engagement element; and in response to moving the locking assembly from the unlocked configuration to the locked configuration, the second engagement element moves towards the first engagement element along the pivot shaft axis to engage the first engagement element.

In an embodiment, the pivot has an annular track around the pivot shaft; the pivot ring has an annular protrusion disposed in the annular track; and the annular protrusion and the annular track cooperate to define rotational movement of the pivot ring about the pivot shaft.

In an embodiment, the pivot ring defines an aperture disposed around the pivot shaft.

In an embodiment, the first pivot arrangement further comprises a handle coupling element disposed within the aperture of the pivot ring to pivotally coupled the handle to the pivot.

In an embodiment, the pivot ring has an annular ledge within the aperture; and the handle coupling element engages the annular ledge and is coupled to the pivot.

In an embodiment, the annular ledge and the annular protrusion are disposed between the pivot and the handle coupling element.

In an embodiment, the second engagement element is disposed on the handle coupling element.

In an embodiment, the locking assembly further comprises a biasing element configured to bias the second engagement element away from the first engagement element when the locking assembly is in the unlocked configuration.

In an embodiment, the locking assembly further comprises a biasing element disposed on the handle coupling element, the biasing element configured to bias the second engagement element away from the first engagement element when the locking assembly is in the unlocked configuration.

In an embodiment, the biasing element contacts the handle coupling element and the second engagement element.

In an embodiment, the locking assembly further comprises a locking adjustment member configured to move the locking assembly between the locked and unlocked configurations.

In an embodiment, the locking adjustment member has at least one cam; the second engagement element has at least one cam follower profile engaged with the at least one cam; and the at least one cam and the at least one cam follower profile cooperate with each other to engage and disengage the second engagement element with the first engagement element when moving the locking assembly between the locked and unlocked configurations.

In an embodiment, the locking adjustment member and handle coupling element cooperate with each other to limit movement of the locking adjustment member between a locked position in which the locking assembly is in the locked configuration and an unlocked position in which the locking assembly is in the unlocked configuration.

In an embodiment, the locking adjustment member is movable between the locked and unlocked positions by rotating the locking adjustment member about the pivot shaft axis.

In an embodiment, the locking adjustment member is a lever.

In an embodiment, the first engagement element has an engagement structure; the second engagement element has an engagement structure; in the locked position, the engagement structures of the first and second engagement elements are engaged with each other to restrict rotation of the handle about the first pivot arrangement; and in the unlocked position, the engagement structures of the first and second engagement elements are disengaged from each other, thereby allowing the handle to rotate about first pivot arrangement.

In an embodiment, the first engagement structure and second engagement structure engage in an interference fit.

In an embodiment, the cooking appliance is a sandwich press or grill.

Further aspects of the present invention and further embodiments of the aspects described in the preceding paragraphs will become apparent from the following description, given by way of example and with reference to the accompanying drawings.

### BRIEF DESCRIPTION OF THE DRAWINGS

Embodiments of the present invention are described, by way of examples only, with reference with the accompanying figured, wherein:

FIG. 1 is a perspective view of a cooking appliance according to a first embodiment in a closed configuration;

FIG. 2 is a perspective view of the cooking appliance of FIG. 1 in an open configuration;

FIG. 3 is a perspective view of the lower cooking plate of the cooking appliance of FIG. 1 and an exploded parts view of the handle and locking assembly of the cooking appliance of FIG. 1;

FIG. 4 provides an enlarged view of the components within the box of FIG. 3;

FIG. 5 is a rear perspective view of the side arm and pivot ring of the handle of the cooking appliance of FIG. 1;

FIG. 6 is a perspective view of the first end of the handle coupling element of the locking assembly of FIG. 3;

FIG. 7 is a perspective view of the locking engagement element of the locking assembly of FIG. 3;

FIG. 8 is a side view of the locking adjustment member of the locking assembly of FIG. 3;

FIG. 9 shows the locking adjustment member of the cooking appliance of FIG. 1 in a locked position;

FIG. 10 shows the locking adjustment member of the cooking appliance of FIG. 1 in an unlocked position;

FIG. 11A illustrates the cooking appliance of FIG. 1 in a closed position with the locking adjustment member in the locked position;

FIG. 11B illustrates the cooking appliance of FIG. 1 in a closed position with the locking adjustment member in the unlocked position;

FIG. 11C illustrates how the cooking appliance of FIG. 1 is moved between the open and closed positions with the locking assembly in the unlocked configuration;

FIG. 11D illustrates the cooking appliance of FIG. 1 in an open position with the locking adjustment member in the locked position;

FIG. 12 is a perspective view of a cooking appliance according to a second embodiment in a closed configuration;

FIG. 13 is a perspective view of the cooking appliance of FIG. 12 in an open configuration;

FIG. 14 provides a partial rear perspective view of the cooking appliance of FIG. 12 and a partial exploded parts view of handle and the locking assembly of the cooking appliance of FIG. 12;

FIG. 15 shows the locking adjustment member of the cooking appliance of FIG. 12 in a locked position;

FIG. 16 shows the locking adjustment member of the cooking appliance of FIG. 12 in an unlocked position;

FIG. 17A illustrates the cooking appliance of FIG. 12 in a closed position with the locking adjustment member in the locked position;

FIG. 17B illustrates the cooking appliance of FIG. 12 in a closed position with the locking adjustment member in the unlocked position;

FIG. 17C illustrates how the cooking appliance of FIG. 12 is moved between the open and closed positions with the locking adjustment member in the unlocked position;

FIG. 17D illustrates the cooking appliance of FIG. 12 in an open position with the locking adjustment member in the locked position

FIG. 18 is a perspective view of a cooking appliance according to a third embodiment in a closed configuration;

FIG. 19 is a perspective view of the cooking appliance of FIG. 18 in an open configuration;

FIG. 20 provides a perspective view of the lower cooking plate of the cooking appliance of FIG. 18 and an exploded parts view of the handle and locking assembly of the cooking appliance of FIG. 18;

FIG. 21 provides an enlarged partial view of the components within the box of FIG. 20;

FIG. 22 shows the locking adjustment member of the cooking appliance of FIG. 18 in a locked position;

FIG. 23 shows the locking adjustment member of the cooking appliance of FIG. 18 in an unlocked position;

FIG. 24A illustrates the cooking appliance of FIG. 18 in a closed position with the locking adjustment member in the locked position;

FIG. 24B illustrates the cooking appliance of FIG. 18 in a closed position with the locking adjustment member in the unlocked position;

FIG. 24C illustrates how the cooking appliance of FIG. 18 is moved between the open and closed positions with the locking assembly in the unlocked configuration;

FIG. 24D illustrates the cooking appliance of FIG. 18 in an open position with the locking adjustment member in the locked position;

FIG. 25 is a perspective view of a cooking appliance according to a fourth embodiment in a closed configuration;

FIG. 26 is a perspective view of the cooking appliance of FIG. 25 in an open configuration;

FIG. 27 is a perspective view of the cooking appliance of FIG. 25, omitting the drip tray;

FIG. 28 is a front view of the cooking appliance of FIG. 25, omitting the drip tray;

FIG. 29 is a perspective view of the cooking appliance of FIG. 25 with the drip tray removed from the void of the lower housing of the cooking appliance;

FIG. 30 is a perspective view of the drip tray of the cooking appliance of FIG. 25; and

FIGS. 31A-C illustrate how the angle of the lower cooking plate of the cooking appliance of FIG. 25 can be varied by moving the drip tray into and out of the void of the cooking appliance.

### DETAILED DESCRIPTION OF THE EMBODIMENTS

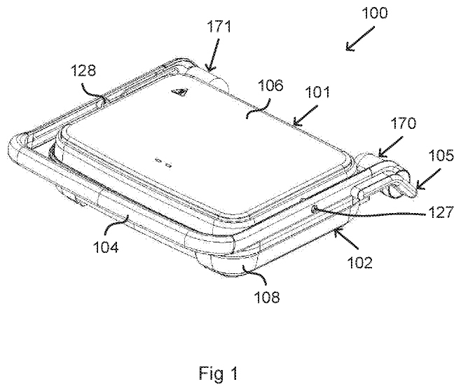

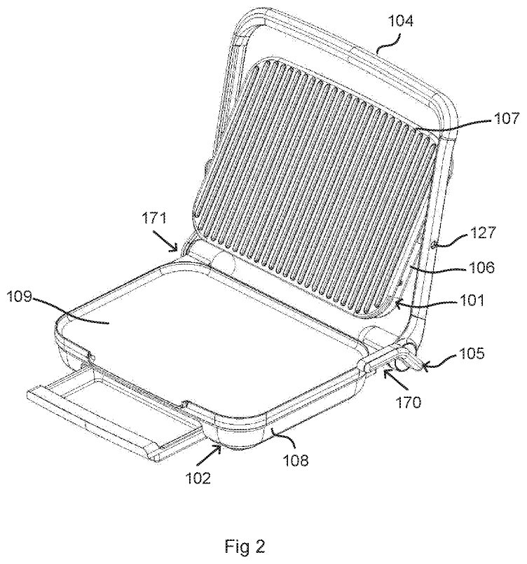

FIGS. 1 and 2 show a cooking appliance 100 according to a first embodiment of the present invention in the form of a sandwich press and/or grill in a closed and open position, respectively. The cooking appliance 100 has an upper cooking assembly 101, a lower cooking assembly 102, and a locking assembly 105.

The upper cooking assembly 101 has an upper housing 106 and an upper cooking plate 107 accommodated by the upper housing 106. The lower cooking assembly 102 includes a lower housing 108 and a lower cooking plate 109 accommodated by the lower housing 108. The upper cooking assembly 101 is pivotable with respect to the lower cooking assembly 102 about a pivot arrangements or assemblies 170 and 171.

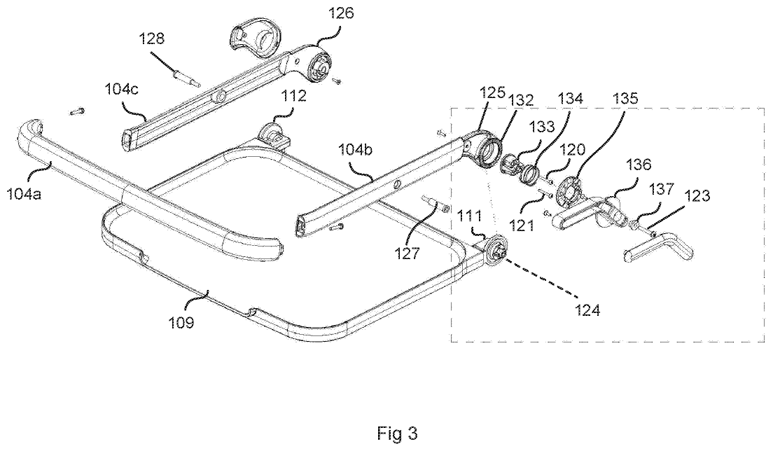

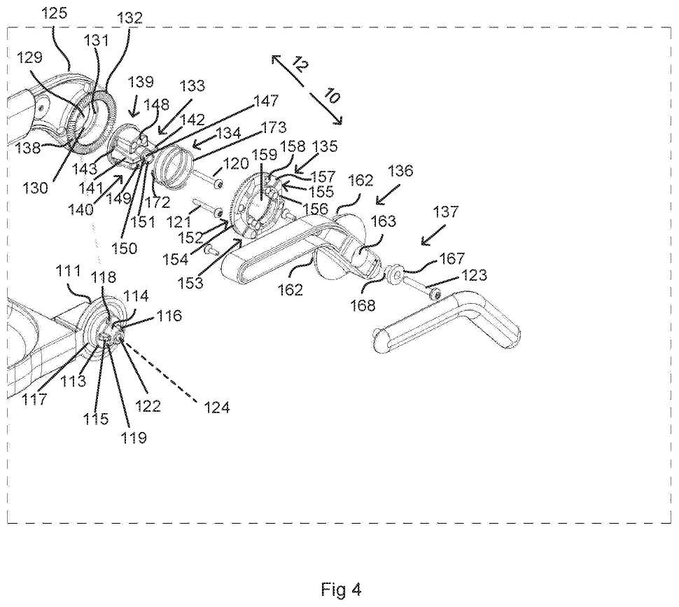

Referring to FIGS. 3 and 4, the lower cooking plate 109 of the lower cooking assembly 102 has a pivot hub 111 and a pivot hub 112. The pivot hub 111 has a base 113, a pivot shaft 114 extending from the base 113, a first projection 115, a second projection 116, and an annular track 117 extending around the base 113 and the pivot shaft 114. The first and second projections 115 and 116 are connected to the base 113 and the pivot shaft 114 and are disposed on opposite sides of the pivot shaft 114. The base 113 has a pair of fastener apertures 118 and 119, each configured to receive a fastener (e.g. fasteners 120 and 121 discussed below). The pivot shaft 114 has a fastener aperture 122 configured to receive a fastener (e.g. fastener 123 discussed below). The pivot shaft 114 defines a pivot shaft axis 124.

The handle 104 has a front portion 104a and a pair of side arms 104b and 104c. Side arm 104b terminates in a pivot ring 125 and side arm 104c terminates in pivot ring 126. Handle pivot arrangements or assemblies 127 and 128 are carried on the side arms 104b and 104c, respectively.

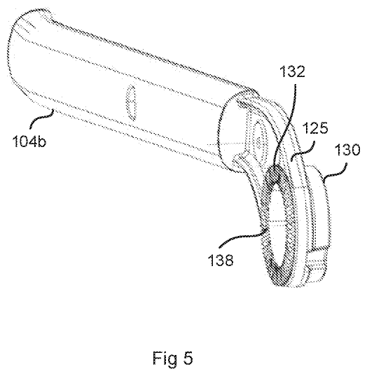

The pivot ring 125 has an aperture 129, an annular protrusion 130 (see FIG. 5) configured to engage and cooperate with the annular track 117 of the pivot hub 111, and an annular ledge 131 within the aperture 129.

The locking assembly 105 has a handle engagement element 132, a handle coupling element 133, a biasing means 134 in the form of a spring, a locking engagement element 135, a locking adjustment member 136 in the form of a lever, and a bearing washer 137.

The handle engagement element 132 is disposed around the aperture 129 of the pivot ring 125 and comprises a handle engagement structure 138 in the form of a plurality of radially extending serrations. The handle engagement element 132 may be integral with the pivot ring 125 or a separate component coupled to the pivot ring 125.

The handle coupling element 133 has a first end 139, a second end 140 opposite the first end 139, a pair of axial protrusion 141 and 142 extending between the first end 139 and the second end 140, and lip 143 extending around the first end 139. The axial protrusions 141 and 142 taper from the first end 139 to the second end 140.

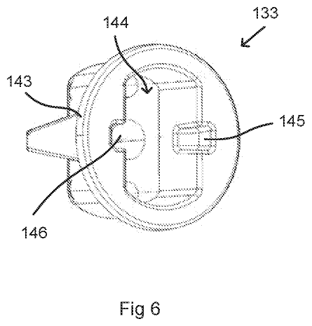

Referring to FIG. 6, the first end 139 of the handle coupling element 133 defines a receptacle 144 having a first recess 145 and a second recess 146. The first and second recesses 145 and 146 of the receptacle 144 are configured to receive the first and second projections 115 and 116 of the pivot hub 111, respectively. When the first and second projections 115 and 116 are received in the respective first and second recesses 145 and 146, the first and second recesses 145 and 146 cooperate with the first and second projections 115 and 116 to correctly locate the handle coupling element 133 on the pivot hub 111 and to restrict/prevent rotation of the handle coupling element 133 relative to the pivot hub 111 about the pivot shaft axis 124.

Referring to FIGS. 3 and 4, the handle coupling element 133 has an opening 147, a pair of holes 148 and 149, and a stop element 150 having a stop surface 151. The stop element 150 extends halfway around the opening 147. The opening 147 is configured such that a fastener (e.g. fastener 123 discussed below) can extend through the opening 147 and the handle coupling element 133. Each hole 148, 149 is configured such that a fastener (e.g. fastener 120 or 121) can extend through the hole 148, 149 and the handle coupling element 133.

The locking engagement element 135 has a first side 152 and a second side 153. The first side 152 of the locking engagement element 135 has a locking engagement structure 154 in the form of a plurality of radially extending serrations. The locking engagement structure 154 is complementary to the handle engagement structure 138. The second side 153 of the locking engagement element 135 has a plurality of cam follower profiles 155. Each cam follower profile 155 has a cam seat 156 and a cam ridge 157. Each cam ridge 157 has a cam ridge recess 158.

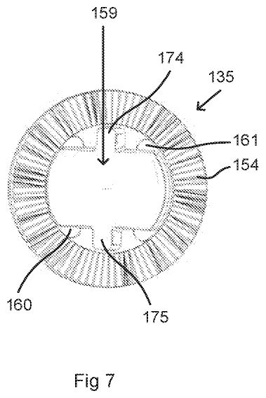

The locking engagement element 135 also defines an aperture 159 and a pair of biasing means engagement surfaces 160 and 161 and a pair of slots 174 and 175 (see FIG. 7). Each of the biasing means engagement surfaces 160 and 161 extend partially around the aperture 159.

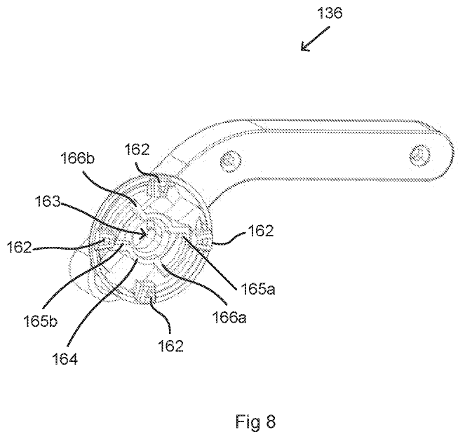

Referring to FIG. 8, the locking adjustment member 136 has a plurality of cams 162, an aperture 163, and a rotational restriction element 164. The number of cams 162 is equal to the number of cam follower profiles 155 on the locking engagement element 135. The rotational restriction element 164 has a pair of first stop surfaces 165a and 165b, and a pair of second stop surfaces 166a and 166b.

Referring to FIG. 4, the bearing washer 137 has a head portion 167, an abutting portion 168, and an aperture 169. The aperture 169 is configured such that a fastener (e.g. fastener 123 discussed below) can extend through the bearing washer 137. The bearing washer 137 provides a bearing surface for the fastener passing through the aperture 169.

Referring to FIGS. 1 and 2, the lower cooking plate 109 is at least partially received in the lower housing 108 and the upper cooking plate 107 is at least partially received in the upper housing 106. The upper cooking assembly 101 is pivotally coupled to the handle 104 by the handle pivot arrangements 127 and 128 such that the upper cooking assembly 101 is able to rotate with respect to the handle 104 about the handle pivot arrangements 127 and 128. The handle pivot arrangements 127 and 128 are illustrated in FIGS. 3 and 4 as pivot pins, however, it will be appreciated that any suitable pivot arrangements or assemblies known in the art to pivotally couple the upper cooking assembly 101 to the handle 104 may be used.

Referring to FIGS. 3 and 4, the pivot ring 125 is pivotally coupled to the pivot hub 111 and the pivot ring 126 is pivotally coupled to the pivot hub 112 such that the handle 104 is able to pivot with respect to the lower cooking assembly 102 about the pivot hubs 111 and 112. The pivot ring 125 is disposed on the pivot hub 111 such that the annular protrusion 130 is received in the annular track 117, and the pivot shaft 114 and first and second projections 115 and 116 are disposed within the aperture 129 of the pivot ring 125. The annular protrusion 130 and the annular track 117 cooperate to define the pivoting/rotational motion of the pivot ring 125, and therefore the handle 104, about the pivot shaft axis 124 relative to the pivot hub 111.

The handle coupling element 133 is disposed within the aperture 129 of the pivot ring 125 such that the first end 139 of the handle coupling element 133 engages the annular ledge 131 of the pivot ring 125, and the first and second projections 115 and 116 of the pivot hub 111 are received in the first and second recesses 145 and 146 of the receptacle 144 of the handle coupling element 133, respectively. As discussed above, the first and second projections 115 and 116 cooperate with the first and second recesses 145 and 146, respectively, to restrict/prevent rotation of the handle coupling element 133 relative to the pivot hub 111 about the pivot shaft axis 124.

pivot hub 111 The handle coupling element 133 is coupled to the pivot hub 111 by fasteners 120 and 121 extending through the handle coupling element 133 and engaging fastener apertures 118 and 119, respectively. The fastener 120 extends through the hole 148 of the handle coupling element 133, through the handle coupling element 133, and engages the fastener aperture 118. The fastener 121 extends through the hole 149 of the handle coupling element 133. through the handle coupling element 133, and engages the fastener aperture 119. With the handle coupling element 133 coupled to the pivot hub 111, the annular protrusion 130 and the annular ledge 131 of the pivot ring 125 are sandwiched between the annular track 117 of the pivot hub 111 and the first end 139 of the handle coupling element 133, thereby pivotally coupling the pivot ring 125, and therefore the handle 104, to the pivot hub 111. The pivot hub 111, the pivot ring 125, and the handle coupling element 133 together form a pivot arrangement 170. The pivot ring 126 and the pivot hub 112 together form a pivot arrangement 171.

The biasing element 134 is disposed over and around the handle coupling element 133 such that a first end 172 of the biasing element 134 engages the lip 143 of the handle coupling elements 133. The locking engagement element 135 is disposed on the handle coupling element 133 such that the first axial protrusion 141 and the second axial protrusion 142 of the handle coupling element 133 extend through the aperture 159 of the locking engagement element 135. The first axial protrusion 141 and the second axial protrusion 142 extend past the second side 153 of the locking engagement element 135 in the direction generally indicated by arrow 10 (see FIG. 4). The locking engagement element 135 is disposed on the handle coupling element 133 such that the biasing means engagement surfaces 160 and 161 of the locking engagement element 133 engage a second end 173 of the biasing means 134, and the handle engagement structure 138 faces the locking engagement structure 154.

The locking engagement element 135 is disposed on the handle coupling element 133 such that the head of the fastener 120 is at least partially received in the slot 174 of locking engagement element 135 and the head of the fastener 121 is at least partially received in the slot 175 of locking engagement element 135. The heads of the fasteners 120 and 121 cooperate with the respective slots 174 and 175 of the locking engagement element 135 to allow the locking engagement element 135 to move axially along the pivot shaft axis 124 but restrict/prevent the locking engagement element 135 from rotating about the pivot shaft axis 124. Accordingly, when the locking adjustment member 136 is pivotally coupled to the pivot hub 111 (discussed below), the locking engagement element 135 is able to move axially along the pivot shaft axis 124 relative to the handle coupling element 133 but is restricted/prevented from rotating relative to the handle coupling element 133 about the pivot shaft axis 124.

The bearing washer 137 is disposed in the aperture 163 of the locking adjustment member 134 such that the head portion 167 of the bearing washer 137 engages the locking adjustment member 136, thereby preventing the bearing washer 137 from passing through the aperture 163 of the locking adjustment member 136.

The locking adjustment member 136 is pivotally coupled to the shaft 114 of the pivot hub 111 by a fastener 123 extending through the bearing washer 137, through the aperture 163 of the locking adjustment member 136, through the aperture 159 of the locking engagement element 135, through the aperture 147 of the handle coupling element 133, and pivotally engaging the fastening aperture 122 of the shaft 114 of the pivot hub 111. The bearing washer 137 provides a bearing surface for the fastener 123. When the locking adjustment member 136 is pivotally coupled to the pivot hub 111, the abutting portion 168 of the bearing washer 137 abuts the stop surface 151 of the handle coupling element 133. The stop surface 151 and the abutting surface 168 cooperate to restrict/prevent the fastener 123 from rotating with respect to the pivot hub 111 as the locking adjustment member 136 is rotated about the pivot shaft axis 124, thereby preventing/restricting the fastener 123 from being tightened or loosened in the fastener aperture 122 as the locking adjustment member 136 is rotated about the pivot shaft axis 124.

With the locking adjustment member 136 pivotally coupled to the pivot hub 111, the first axial protrusion 141 of the handle coupling element 133 is at least partially disposed between the first abutting surface 165a and the second abutting surface 166a of the locking adjustment member 136. Further, the second axial protrusion 142 of the handle coupling element 133 is at least partially disposed between the first abutting surface 165b and the second abutting surface 166b of the locking adjustment member 136. The first and second axial protrusions 141 and 142, the pair of first abutting surfaces 165a and 165b, and the pair of second abutting surfaces 166a and 166b are configured to cooperate with each other to limit the rotational movement of the locking adjustment member 136 about the pivot shaft axis 124. The locking adjustment member 136 is pivotally coupled to the pivot shaft 143 of the pivot hub 111 such that the locking adjustment member 136 does not move axially along the pivot shaft axis 124 when rotating about the pivot shaft axis 124.

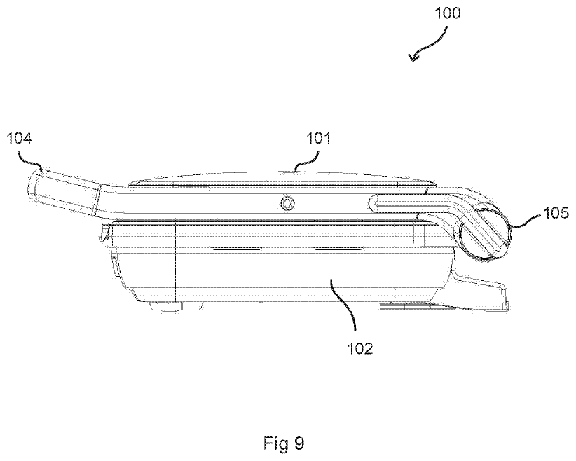

The locking adjustment member 136 is able to rotate about the pivot shaft axis 124 in the anticlockwise direction until the abutting surfaces 165a and 165b of the locking adjustment member 136 abut the first axial protrusion 141 and the second axial protrusion 142 of the handle coupling element 133, respectively. In this position, the locking adjustment member 136 is in a locked position (see FIG. 9).

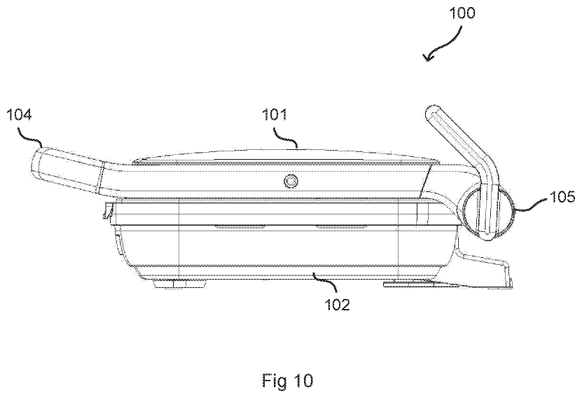

The locking adjustment member 136 is able to rotate about the pivot shaft axis 124 in the clockwise direction until the abutting surfaces 166a and 166b of the locking adjustment member 136 abut the first axial protrusion 141 and the second axial protrusion 142 of the handle coupling element 133, respectively. In this position, the locking adjustment member 136 is in an unlocked position (see FIG. 10). The locking adjustment member 136 is, therefore, movable between the locked and unlocked positions by rotating the locking adjustment member 136 about the pivot shaft axis 124.

The locking assembly 105 is in a locked configuration when the locking adjustment member 136 is in the locked position (see FIG. 9) and the locking assembly 105 is in an unlocked configuration when the locking adjustment member 136 is in the unlocked position (see FIG. 10). The locking assembly 105 is, therefore, movable between the locked and unlocked configurations by rotating the locking adjustment member 136 between the locked and unlocked positions, respectively.

With the locking adjustment member 136 pivotally coupled to the shaft 114 of the pivot hub 111, the first end 172 and the second end 173 of the biasing means 134 engage the lip 143 of the handle coupling element 133 and the biasing means engagement surfaces 160 and 161 of the locking engagement element 135, respectively, to maintain each cam follower profile 155 of the locking engagement element 135 in engagement with one of the cams 162 of the locking adjustment member 136. The biasing means 134, therefore, applies a force on the locking engagement element 135 in the direction generally indicated by arrow 10 (see FIG. 4).

As the locking engagement element 135 is restricted/prevented from rotating about the pivot shaft axis 124 (as discussed above), rotating the locking adjustment member 136 about the pivot shaft axis 124 causes relative rotational movement between the cams 162 of the locking adjustment member 136 and the cam follower profiles 155 of the locking engagement element 135. Further, as the biasing means 134 maintains each cam follower profile 155 in engagement with one of the cams 162 of the locking adjustment member 135, rotating the locking adjustment member 136 to move the locking assembly 105 between the locked and unlocked configurations causes each cam 162 to slide along a respective one of the cam follower profiles 155.

When the locking assembly 105 is in the unlocked configuration, each cam 162 of the locking adjustment member 136 is received in one of the cam seats 156 of the locking engagement element 135. In this configuration, the biasing means 134 urges the locking engagement element 135 axially along the pivot shaft axis 124 relative to the handle coupling element 133 away from the handle engagement element 132 such that the locking engagement structure 154 of the locking engagement element 135 is disengaged from the handle engagement structure 138 of the handle engagement element 132.

Moving the locking assembly 105 from the unlocked configuration to the locked configuration causes each cam 162 to slide out of the corresponding cam seat 156 and onto the corresponding cam ridge 157. When the locking assembly 105 is in the locked configuration, each cam 162 is received in one of the recesses 158 of the cam ridges 157. As the locking adjustment member 136 does not move axially along the pivot shaft axis 124 when being rotated about the pivot shaft axis 124, sliding the cams 162 out of the cam seats 156 and onto the cam ridges 157 causes the locking engagement element 135 to move axially along the pivot shaft axis 124 relative to the handle coupling element 133 towards the handle engagement element 132 by compressing the biasing means 134 in a direction generally indicated by arrow 12. When the locking assembly 105 is in the locked configuration, the locking engagement structure 154 of the locking engagement element 135 is engaged with handle engagement structure 138 of the handle engagement element 132 via an interference fit. As the locking engagement element 135 is restricted/prevented from rotating about the pivot shaft axis 124, the engagement between the locking engagement structure 154 and the handle engagement structure 138 restricts/prevents the pivot ring 125, and therefore the handle 104, from rotating with respect to the lower cooking assembly 102 about the pivot arrangement 170. Accordingly, the locking assembly 105 acts on the pivot arrangement 170 when the locking assembly 105 is in the locked configuration.

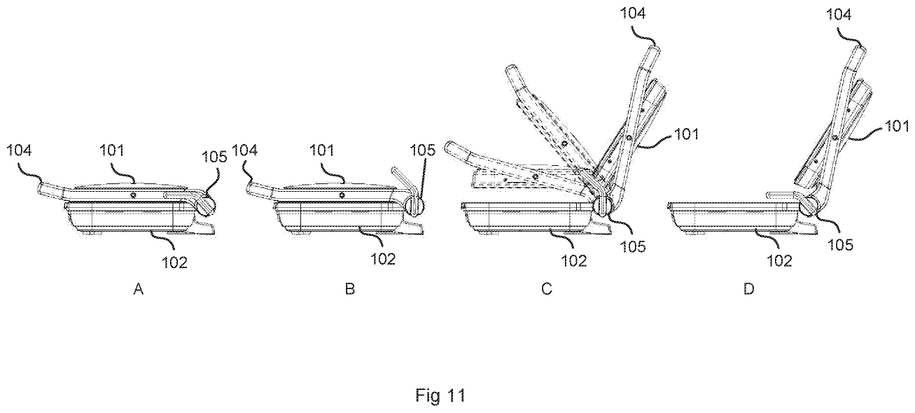

When the locking assembly 105 is in the unlocked configuration, the locking engagement structure 154 and the handle engagement structure 138 are disengaged from each other and the pivot ring 125, and therefore the handle 104, is able to be rotated about the pivot arrangements or assemblies 170 and 171 to move the cooking appliance 100 between the open and closed positions. Referring to FIG. 11, when locking assembly 105 is in the unlocked configuration and the cooking appliance 100 is in the closed position (see FIG. 11B), lifting the handle 104 upwards (see FIG. 11C) will cause the handle 104 to rotate about the pivot arrangements 170 and 171, which will separate the upper cooking assembly 101 from the lower cooking assembly 102. This will allow a user to place food between the upper cooking plate 107 and the lower cooking plate 109. Lowering the handle 104 will move the upper cooking assembly 101 toward the lower cooking assembly 102 so that any food placed on the lower cooking plate 109 will be sandwiched between the upper cooking plate 107 and the lower cooking plate 109 so that the upper cooking plate 107 operates as a contact grill.

As the upper cooking assembly 101 is pivotally coupled to the handle 104 by the handle pivot arrangements or assemblies 127 and 128, the upper cooking assembly 101 is able to rotate with respect to the handle 104, as the handle 104 is rotated about the pivot arrangements 170 and 171 to move the cooking appliance 100 between the open and closed positions. Accordingly, when the upper cooking plate 107 of the upper cooking assembly 101 is brought into contact with food place on the lower cooking plate 109, the upper cooking plate 107 can rotate with respect to the handle 104 such that contact between the upper cooking plate 107 and the food may be maximised. Once the upper cooking plate 107 is at a position where it is in contact with the food disposed on the lower cooking plate 109, a user can rotate the locking adjustment member 136 to the locked position to move the locking assembly 105 from the unlocked configuration to the locked configuration, thereby releasably retaining the upper cooking assembly 101 at that position via the engagement of the handle engagement structure 138 and the locking engagement structure 154.

Referring to FIG. 11C, for a predetermined range of rotation of the handle 104 with respect to the lower cooking assembly 102, the upper cooking assembly 101 is able to rotate with respect to the handle 104, as the handle 104 is rotated to move the cooking appliance 100 between the open and closed positions such that the upper cooking plate 107 remains facing the lower cooking plate 109 while the handle 104 is being rotated through this range. Accordingly, the locking assembly 105 is able to retain the upper cooking assembly 101 at a plurality of distances or positions with respect to the lower cooking plate 109 by engaging the locking engagement structure 154 and the handle engagement structure 138 at different relative angular positions with respect to each other.

The width of the serrations of the handle engagement structure 138 and the locking engagement structure 154 determines the number of distances or positions at which the upper cooking assembly 102 may be releasably retained with respect to the lower cooking assembly 102. Increasing the width of the serrations decreases the number of distances or positions, while decreasing the width of the serrations increases the number of distances or positions. Accordingly, the serrations of the handle engagement structure 138 and the locking engagement structure 154 may allow the upper cooking assembly 101 to be retained at more distances or positions with respect to the lower cooking assembly 102 compared to the prior art cooking appliances.

Although the handle engagement structure 138 and the locking engagement structure 154 have been described an illustrated as a plurality of radially extending serrations, it is envisaged that other interference fit structures with varying profiles defining different numbers of discreet positions may be used to restrict/prevent the handle 104 from rotating with respect to the lower cooking assembly 102 about the pivot arrangements 170 and 171.

It is also that the handle engagement element 132 and the locking engagement element 135 may not include the handle engagement structure 138 and the locking engagement structure 154, respectively. Instead, the handle engagement element 132 may engage the locking engagement element 135 via friction. In this case, the surfaces of the handle engagement element 132 and the locking engagement element 135 that are configured to engage with each other may have a high coefficient of friction.

Further, although the pivot hubs 111 and 112 have been described and illustrated as being part of the lower cooking plate 109, it is also envisaged that the lower housing 108 of the lower cooking assembly 102 could instead comprises the pivot hubs 111 and 112.

It is also envisaged that the cams 162 of the locking adjustment member 136 may be integral with the locking adjustment member 136 or may be part of one or more separate components coupled to the locking adjustment member 136.

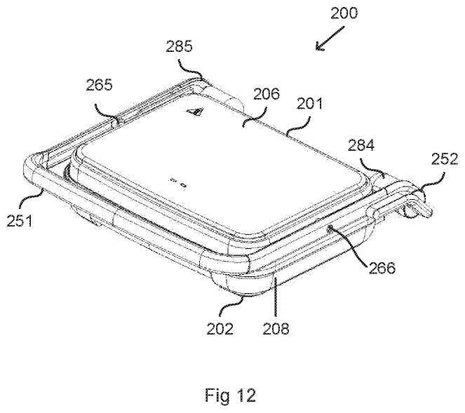

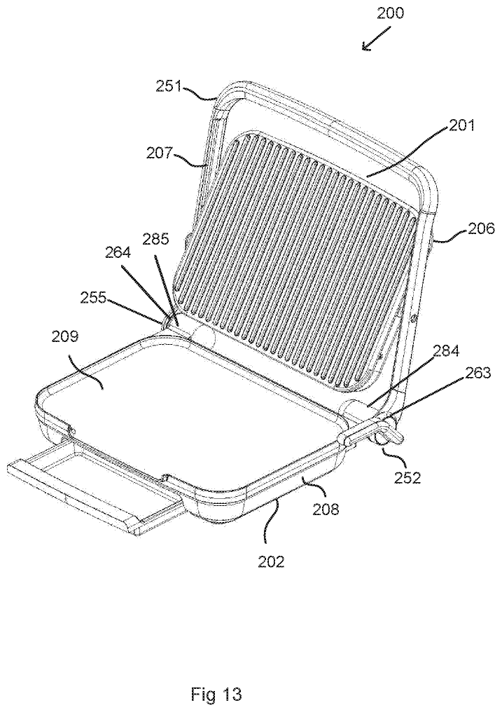

FIGS. 12 and 13 show a cooking appliance 200 according to a second embodiment of the present invention in the form of a sandwich press and/or grill in a closed and open position. respectively. The cooking appliance 200 is similar to the cooking appliance 100, however, the lower cooking plate 209, the handle 251, and the locking assembly 252 of the cooking appliance 200 are different to the lower cooking plate 109, handle 104, and locking assembly 105 of the cooking appliance 100, respectively.

The upper cooking assembly 201 has an upper housing 206 and an upper cooking plate 207 accommodated by the upper housing 206. The lower cooking assembly 202 has a lower housing 208 and a lower cooking plate 209 accommodated by the lower housing 208. The upper cooking assembly 201 is pivotable with respect to the lower cooking assembly 202 about a pivot arrangement 284 and a pivot arrangement 285.

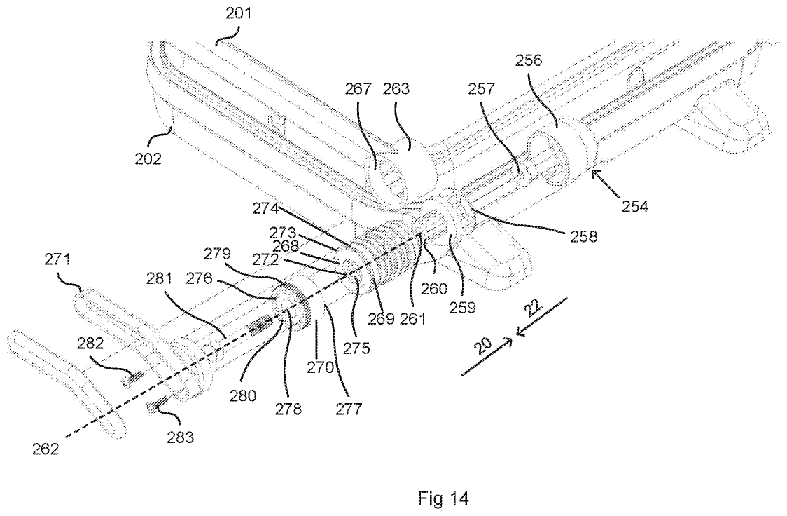

Referring to FIG. 14, the lower cooking plate 209 of the lower cooking assembly 202 has a pivot hub 254, and a pivot hub 255 (see FIG. 13) opposite the pivot hub 254. The pivot hub 254 has a base 256 having an aperture 257 configured to receive a fastener (e.g. fastener 281 discussed below) and a pivot spindle 258.

The pivot spindle 258 has a pivot spindle base 259, a pivot shaft 260 extending from the pivot spindle base 259, and a pivot spindle aperture 261 extending through the pivot spindle 258. The pivot shaft 260 has a pivot shaft axis 262 along which the pivot shaft defines a pivot shaft profile.

The handle 251 has a pivot ring 263, a pivot ring 264 (see FIG. 13) opposite the pivot ring 263, a handle pivot arrangement 265 (see FIG. 12), and a handle pivot arrangement 266 (see FIG. 12). The pivot ring 263 has an inner surface 267 that defines a pivot ring profile.

The locking assembly 252 has a plurality of handle engagement elements 268, a plurality of pivot engagement elements 269, a compressing member 270, and a locking adjustment member 271 in the form of a lever.

Each handle engagement element 268 has an aperture 272 and an outer edge 273 that defines an outer edge profile. The outer edge profile of each handle engagement element 269 complements the pivot ring profile of the inner surface 267 of the pivot ring 263.

Each pivot engagement element 269 has an outer edge 274 and an aperture 275 that defines an aperture profile. The aperture profile of each pivot engagement element 269 complements the pivot shaft profile of the pivot shaft 260.

The compressing member 270 has a first end 276, a second end 277, an aperture 278 extending through the compressing member 270, and engagement structure 279 disposed around the first end 276, and a plurality of openings 280 each configured to receive a fastener (e.g. fasteners 282 and 283 discussed below).

The plurality of handle engagement elements 268 and the plurality of pivot engagement elements 269 are disposed on the pivot shaft 260 in an interleaved manner such that the pivot shaft 260 is received through the aperture 272 of each handle engagement element 268 and the aperture 275 of each pivot engagement element 269. Each handle engagement element 268 is able to move axially along the pivot shaft 260 and rotate about the pivot shaft axis 262 of the pivot shaft 260. As the aperture profile of each pivot engagement element 269 complements the pivot shaft profile of the pivot shaft 260, each pivot engagement element 269 is able to move axially along the pivot shaft 260 but is restricted/prevented from rotating about the pivot shaft axis 262 of the pivot shaft 260. Accordingly, the aperture profiles of each pivot engagement element 269 cooperate with the pivot shaft profile of the pivot shaft 260 to restrict/prevent rotation of each pivot engagement element 269 about the pivot shaft axis 262 of the pivot shaft 260.

Referring to FIGS. 12 and 13, the lower cooking plate 209 is at least partially received in the lower housing 208 and the upper cooking plate 207 is at least partially received in the upper housing 206. The upper cooking assembly 201 is pivotally coupled to the handle 251 by the handle pivot arrangements 265 and 266 such that the upper cooking assembly 201 is able to rotate with respect to the handle 251 about the handle pivot arrangements 265 and 266. The handle pivot arrangements 265 and 266 are illustrate in FIGS. 12 and 13 as pivot pins, however, it will be appreciated that any suitable pivot arrangements known in the art to pivotally couple the upper cooking assembly 201 to the handle 251 may be used.

The pivot ring 263 is pivotally coupled to the pivot hub 254 and the pivot ring 264 is pivotally coupled to the pivot hub 255 such that the handle 251 is able to pivot with respect to the lower cooking assembly 202 about the pivot hubs 254 and 255. With the pivot ring 263 pivotally coupled to the pivot hub 111263, the pivot ring 263 is disposed around the pivot shaft 260 such that the pivot shaft 260 extends through the pivot ring 263. The pivot ring 263 and the pivot hub 254 together form the pivot arrangement 284 and the pivot ring 264 and the pivot hub 255 together form the pivot arrangement 285.

With the pivot ring 263 pivotally coupled to the pivot hub 254, the pivot shaft 260, the plurality of handle engagement elements 268, and the plurality of pivot engagement elements 269 are received within the pivot ring 263. As the outer edge profile of the outer edge 273 of each handle engagement element 268 complements the pivot ring profile of the inner surface 267 of the pivot ring 263, each handle engagement element 268 is restricted from rotating with respect to the pivot ring 263. Accordingly, the outer edge profile of each handle engagement element 268 cooperates with the pivot ring profile of the inner surface 267 of the pivot ring 263 to restrict/prevent rotation of each handle engagement element 268 with respect to the pivot ring 263. The pivot ring 263 is able to rotate with respect to each of the pivot engagement elements 269. Each of the handle engagement elements 268 and each of the pivot engagement elements 269 are able to move axially along the pivot shaft axis 272 of the pivot shaft 260 with respect to the pivot ring 263.

The compressing member 270 is pivotally coupled to the base 256 of the pivot hub 254 by a fastener 281 extending through the aperture 278 of the compressing member 270. through the pivot spindle aperture 261, and pivotally engaging the aperture 257 of the base 256. When the compressing member 270 is pivotally coupled to the base 256, the compressing member 270 retains the plurality of handle engagement elements 268 and the plurality of pivot engagement elements 269 on the pivot shaft 260 between the second end 277 of the compressing member 270 and the pivot spindle base 259.

The compressing member 270 is able to rotate clockwise and anticlockwise about the pivot shaft axis 262 of the pivot shaft 260 but is restricted/prevented from rotating with respect to the fastener 281. Accordingly, the compressing member 270 and the fastener 281 are rotatable together about the pivot shaft axis 262 of the pivot shaft 260.

The locking adjustment member 271 is coupled to the first end 276 of the compressing member 270 by a pair of fasteners 282 and 283 each extending through the locking adjustment member 271 and engaging one of the plurality of openings 280 such that the compressing member 270 cannot rotate with respect to the locking adjustment member 271. The engagement structure 279 of the compressing member 270 engages a complementary engagement structure on the locking adjustment member 271 to also restrict/prevent the compressing member 270 from rotating with respect to the locking adjustment member 271. As the locking adjustment member 271 is coupled to the compressing member 270, the locking adjustment member 271 is able to rotate about the pivot shaft axis 262 of the pivot shaft 260. Accordingly, rotating the locking adjustment member 271 causes the compressing member 270 to rotate.

Referring to FIG. 14, when the locking adjustment member 271 is rotated clockwise, the compressing member 270 and the fastener 281 rotate clockwise. Rotating the fastener 281 clockwise causes the fastener 281 to cooperate with the aperture 257 of the base 256 to move the fastener 281 and the compressing member 270 axially along the pivot shaft axis 262 of the pivot shaft 260 toward the pivot spindle base 259 in the direction general indicated by arrow 20.

When the locking adjustment member 271 is rotated anticlockwise, the compressing member 270 and the fastener 281 rotate anticlockwise. Rotating the fastener 281 anticlockwise causes the fastener 281 to cooperate with the aperture 257 of the base 256 to move the fastener 281 and the compressing member 270 axially along the pivot shaft axis 262 of the pivot shaft 260 away from the pivot spindle base 259 in the direction general indicated by arrow 22.

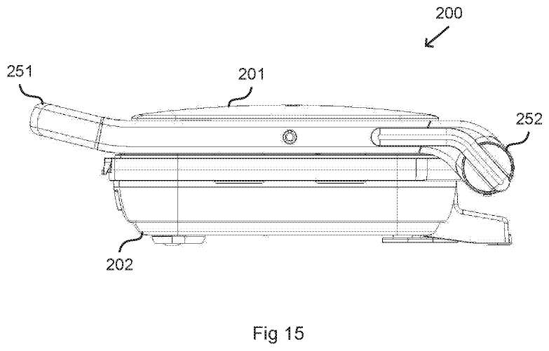

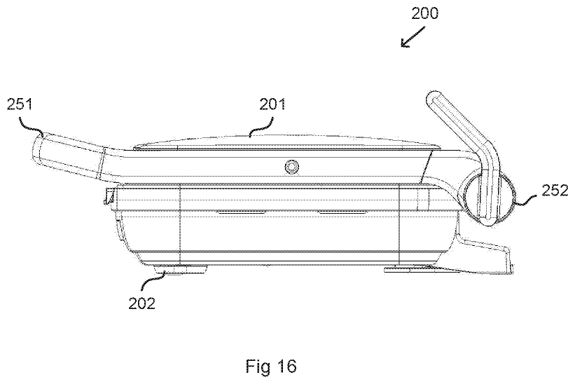

FIGS. 15 and 16 show the locking adjustment member 271 in a locked position and an unlocked position, respectively. Moving the locking adjustment member 217 from the unlocked position to the locked position involves rotating the locking adjustment member 271 anticlockwise about the pivot shaft axis 262. Moving the locking adjustment member 217 from the locked position to the unlocked position involves rotating the locking adjustment member 271 clockwise about the pivot shaft axis 262.

Referring to FIG. 14, when moving the locking adjustment member 271 from the unlocked position to the locked position, the compressing member 270 moves axially towards the pivot spindle base 259 along the pivot shaft axis 262 of the pivot shaft 260, thereby compressing the plurality of handle engagement elements 268 and the plurality of pivot engagement elements 269 between the second end 277 of the compressing member 270 and the pivot spindle base 259. When moving the locking adjustment member 271 from the locked position to the unlocked position, the compressing member 270 moves away from the pivot spindle base 259 along the pivot shaft axis 262 of the pivot shaft 260 to allow the plurality of handle engagement elements 268 and the plurality of pivot engagement elements 269 to separate from each other along the pivot shaft 260. Accordingly, when moving the locking adjustment member 271 from the locked position to the unlocked position, one or more of the handle engagement elements 268 and one or more of the pivot engagement elements 269 move away from the pivot spindle base 259 and each other along the pivot shaft axis 262 of the pivot shaft 260. When moving the locking adjustment member 271 from the unlocked position to the locked position, one or more of the handle engagement elements 268 and one or more of the pivot engagement elements 269 move toward the pivot spindle base 259 and each other along the pivot shaft axis 262 of the pivot shaft 260.

When the locking adjustment member 271 is in the locked position (see FIG. 15), the locking assembly 252 is in a locked configuration. In this configuration, the compressing member 270 compresses the plurality of handle engagement elements 268 and the plurality of pivot engagement elements 269 between the second end 277 of the compressing member 270 and the pivot spindle base 259 such that each handle engagement element 268 frictionally engages an adjacent pivot engagement element 269. As the pivot engagement elements 269 are restricted/prevented from rotating about the pivot shaft axis 262 of the pivot shaft 260, the frictional engagement between the plurality of handle engagement elements 268 and the plurality of pivot engagement elements 269 restricts/prevents the plurality of handle engagement elements 268 from rotating about the pivot shaft axis 262 of the pivot shaft 260. Accordingly, as the handle engagement elements 268 are restricted/prevented from rotating with respect to the pivot ring 263 of the handle 251, the frictional engagement between the plurality of handle engagement elements 268 and the plurality of pivot engagement elements 269 restricts/prevents the handle 251 from rotating with respect to the lower cooking assembly 202 about the pivot arrangement 284. Accordingly, the locking assembly 252 acts on the pivot arrangement 284 when the locking assembly 252 is in the locked position

When the locking adjustment member 271 is in the unlocked position (see FIG. 16), the locking assembly 252 is in an unlocked configuration. In this configuration, the compressing member 270 is moved away from the pivot spindle base 259 along the pivot shaft axis 262 of the pivot shaft 260 such that each handle engagement element 268 is at least partially disengaged from an adjacent pivot engagement element 269. As the handle engagement elements 268 are at least partially disengaged from the pivot engagement elements 269, each handle engagement element 268 is able to rotate about the pivot shaft axis 262 of the pivot shaft 260. As the handle engagement elements 268 are able to rotate about the pivot shaft axis 262 of the pivot shaft 260, the handle 251 is able to rotate with respect to the lower cooking assembly 202 about the pivot arrangements 284 and 285. As the handle engagement elements 268 are restricted/prevented from rotating with respect to the pivot ring 263 of the handle 251, rotating the handle 251 with respect to the lower cooking assembly 202 about the pivot arrangement 284 will cause the plurality of handle engagement elements 268 to rotate about the pivot shaft axis 262 of the pivot shaft 260 with the pivot ring 263.

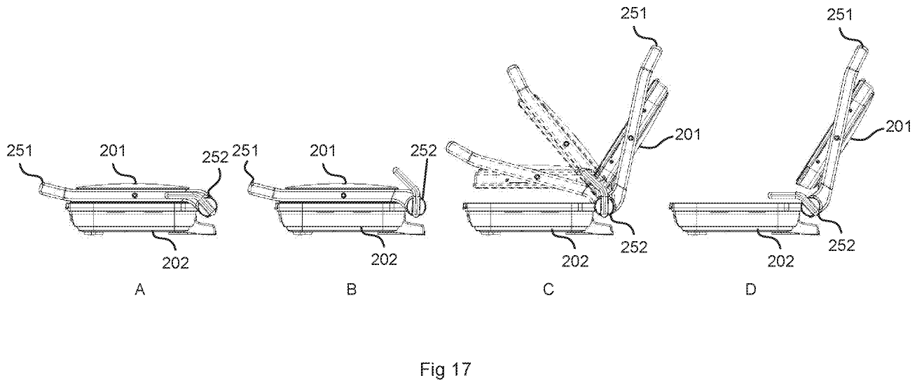

When the locking assembly 252 is in the unlocked configuration, as the pivot engagement elements 269 are at least partially disengaged from the handle engagement elements 268, the handle 251 is able to be rotated about the pivot arrangements 284 and 285 to move the cooking appliance 200 between the open and closed positions. Referring to FIG. 17, when the locking assembly 252 is in the unlocked configuration and the cooking appliance 200 is in the closed position (see FIG. 17B), lifting the handle 251 upwards (see FIG. 17C) will cause the handle 251 to rotate about the pivot arrangements 284 and 285, which will separate the upper cooking assembly 201 from the lower cooking assembly 202. This will allow a user to place food between the upper cooking plate 207 and the lower cooking plate 209. Lowering the handle 251 will move the upper cooking assembly 201 toward the lower cooking assembly 202 so that any food placed on the lower cooking plate 209 will be sandwiched between the upper cooking plate 207 and the lower cooking plate 209 so that the upper cooking plate 207 operates as a contact grill.

As the upper cooking assembly 201 is pivotally coupled to the handle 204 by the handle pivot arrangements 265 and 266, the upper cooking assembly 201 is able to rotate with respect to the handle 251 as the handle 251 is rotated about the pivot arrangements 284 and 285 to move the cooking appliance 200 between the open and closed positions. Accordingly, when the upper cooking plate 207 of the upper cooking assembly 201 is brought into contact with food place on the lower cooking plate 209, the upper cooking plate 207 can rotate with respect to the handle 251 such that contact between the upper cooking plate 207 and the food may be maximised. Once the upper cooking plate 207 is at a position where it is in contact with the food disposed on the lower cooking plate 209, a user can rotate the locking adjustment member 271 to the locked position to move the locking assembly 252 from the unlocked configuration to the locked configuration, thereby retaining the upper cooking assembly 201 at that position via the engagement of the plurality of handle engagement elements 268 and the plurality of pivot engagement elements 269.

Referring to FIG. 17C, for a predetermined range of rotation of the handle 251 with respect to the lower cooking assembly 202, the upper cooking assembly 202 is able to rotate with respect to handle 204, as the handle 204 is rotated to move the cooking appliance 200 between the open and closed positions such that the upper cooking plate 207 remains facing the lower cooking plate 209 while the handle 204 is being rotated through this range. Accordingly, the locking assembly 252 is able to releasably retain the upper cooking assembly 201 at a plurality of positions or distances with respect to the lower cooking plate 209 by frictionally engaging the plurality of handle engagement elements 268 with the plurality of pivot engagement elements 269 at different angular positions with respect to each other.

It will be appreciated that the plurality of handle engagement elements 268 may be frictionally engaged with the plurality of pivot engagement elements 269 at any relative angular position with respect to each other within the range of rotation of the handle 251 with respect to the lower cooking assembly 202. Accordingly, this may allow the upper cooking assembly 201 to be retained at more positions with respect to the lower cooking assembly 202 compared to the prior art cooking appliances.

In an alternate embodiment of the cooking appliance 200, the locking adjustment member 271 may comprise the cams 162 of the locking component 136 of the cooking appliance 100 and the first end 276 of the compressing may 270 may comprises the cam follower profiles 155 from the cooking appliance 100 but not include the engagement structure 279.

In this embodiment, fastener 281 would pivotally couple the locking adjustment member 271 to the aperture 257 of the base 256. The compressing member 270 would be coupled to the pivot shaft 260 such that the pivot shaft 260 is at least partially received in the aperture 278 of the compressing member 270. The profile of the aperture 278 of the compressing member 270 would complement the pivot shaft profile of the pivot shaft 260 such that the compressing member 270 is able to move axially along the pivot shaft axis 262 of the pivot shaft but is restricted/prevented from rotating about the pivot shaft axis 262 of the pivot shaft 260.

In this embodiment, moving the locking assembly 252 between the locked configuration and the unlocked configuration will cause the cams 162 of the locking adjustment member 271 to cooperate with the cam follower profiles 155 of the compressing member 270 similar to what was described above with respect to the cooking appliance 100.

When moving the locking assembly 252 from the locked configuration to the unlocked configuration, the cams 162 of the locking adjustment member 271 will cooperate with corresponding cam follower profiles 155 of the compressing member 270 to move the compressing member 270 away from the pivot spindle base 259 along the pivot shaft axis 262 of the pivot shaft 260. This will allow the plurality of handle engagement elements 268 to at least partially disengage from the plurality of pivot engagement elements 269.

When moving the locking assembly 252 from the unlocked position to the locked position, the cams 162 of the locking adjustment member 271 will cooperate with corresponding cam follower profiles 155 of the compressing member 270 to move the compressing member 270 toward the pivot spindle base 259 along the pivot shaft axis 262 of the pivot shaft 260. This will compress the plurality of handle engagement elements 268 into frictional engagement with adjacent pivot engagement elements 269.

Each handle engagement element 268 may be a friction plate and each pivot engagement element 269 may be a friction disc. However, the plurality of handle engagement elements 268 and the plurality of pivot engagement elements 269 may be any other suitable friction element that is capable of providing the required frictional engagement between the plurality of handle engagement elements 268 and the plurality of pivot engagement elements 269 to retain the upper cooking assembly 201 at a plurality of distances or positions from the lower cooking assembly 202.

It is also envisaged that either or both of the plurality of handle engagement elements 268 and the plurality of pivot engagement elements 269 may be spring plates such that when the locking assembly 252 is moved from the locked configuration to the unlocked configuration, the spring plates will cause the plurality of handle engagement elements 268 and the plurality of pivot engagement elements 269 to at least partially disengage from each other.

It will also be appreciated that the pivot arrangements 284 and 285 may take a number of different forms, with the pivot rings for example being carried on the lower cooking plate 209 and corresponding pivot hubs being carried on the handle 251.

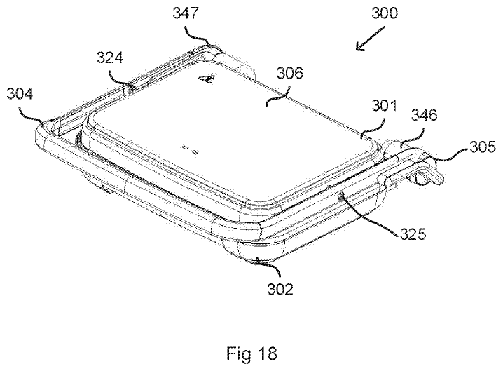

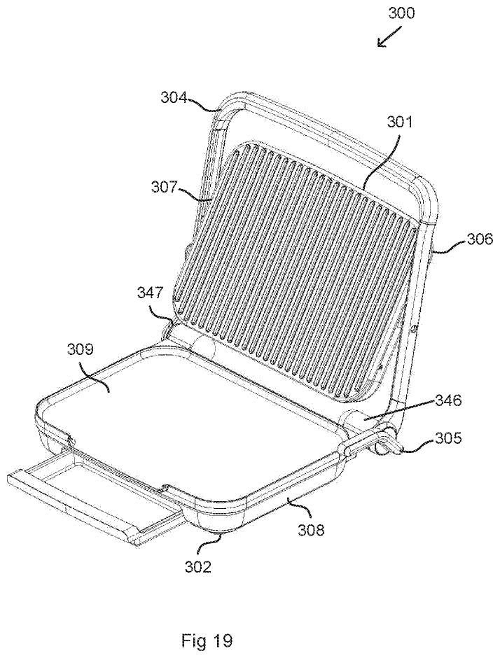

FIGS. 18 and 19 show a cooking appliance 300 according to a third embodiment of the present invention in the form of a sandwich press and/or grill in a closed and open position. respectively. The cooking appliance 300 has an upper cooking assembly 301, a lower cooking assembly 302, a handle 304, and a locking assembly 305.

The upper cooking assembly 301 has an upper housing 306 and an upper cooking plate 307 accommodated by the upper housing 306. The lower cooking assembly 302 has a lower housing 308 and a lower cooking plate 309 accommodated by the lower housing 308. The upper cooking assembly 301 is pivotable with respect to the lower cooking assembly 302 about pivot arrangements including pivot assembly 346 and pivot assembly 347.

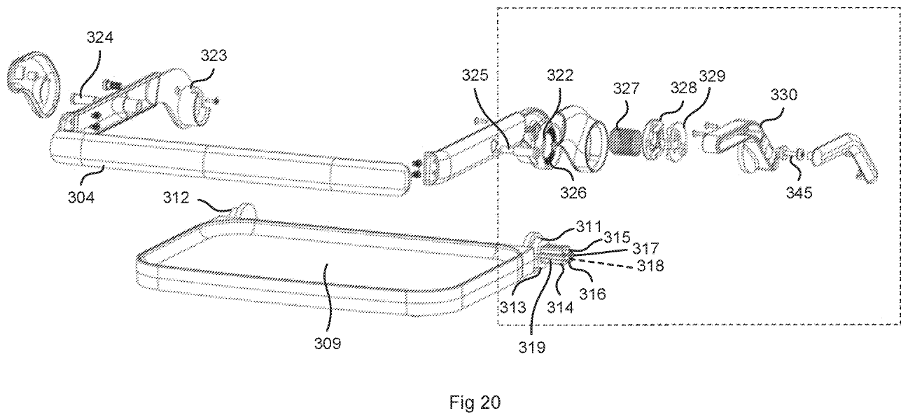

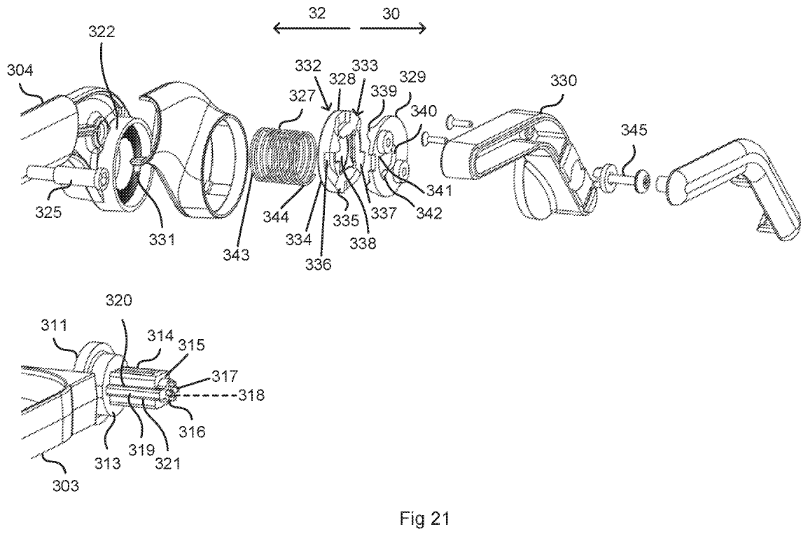

Referring to FIGS. 20 and 21, the lower cooking plate 309 of the lower cooking assembly 302 has a pivot hub 311 and a pivot hub 312. The pivot hub 311 has a pivot base 313, a pivot shaft 314 extending from the pivot base 313, a pivot stop surface 315, a pivot stub 316 disposed at the free end of the pivot shaft, and a pivot shaft aperture 317 configured to receive a fastener (e.g. fastener 345 discussed below).

The pivot shaft 314 has an pivot shaft axis 318 along which the pivot shaft 314 defines a pivot shaft profile. The pivot shaft 314 also has an axial protrusion 319 extending from the pivot base 326 to the free end of the pivot stub 316. The axial protrusion 319 has a first axial surface 320 and a second axial surface 321.

The handle 304 has a front portion 304a and a pair of side arms 304b and 304c terminating in pivot ring 322 and pivot ring 323. Each of the pivot rings are provided with housing portions 322a and 322b. Handle pivot arrangements 324 and 325 are carried on the side arms 304b and 304c, respectively.

The locking assembly 305 has a handle engagement element 326, a biasing means 327 in the form of a spring, a locking engagement element 328, a locking component 329, and a locking adjustment member 330 in the form of a lever.

The handle engagement element 326 is disposed around the pivot ring 322 and has a handle engagement structure 331 in the form of a plurality of radially extending serrations. The handle engagement element 326 may be integral with the handle 304 or a separate component coupled to the handle 304.

The locking engagement element 328 has a first side 332 and a second side 333. The first side 332 of the locking engagement element 328 has a locking engagement structure 334 in the form of a plurality of radially extending serrations. The locking engagement structure 334 is complementary to the handle engagement structure 331. The second side 333 of the locking engagement element 328 has a plurality of cam follower profiles 335. Each cam follower profile having a cam seat 336 and a cam ridge 337.

The locking engagement element 328 also defines an aperture 338. The profile of the aperture 376 is complementary to the profile of the pivot shaft 314.

The locking component 329 has a plurality of cams 339 and an aperture 340. The aperture 340 has a first stop 341 and a second stop 342.

Referring to FIGS. 18 and 19, the lower cooking plate 309 is at least partially received in the lower housing 308 and the upper cooking plate 307 is at least partially received in the upper housing 306. The upper cooking assembly 301 is pivotally coupled to the handle 304 by the handle pivot arrangements 324 and 325 such that the upper cooking assembly 301 is able to rotate with respect to the handle 304 about the handle pivot arrangements 324 and 325. The handle pivot arrangements or assemblies 324 and 325 are illustrated in FIGS. 19 and 20 as pivot pins, however, it will be appreciated that any suitable pivot arrangements or assemblies known in the art to pivotally couple the upper cooking assembly 302 to the handle 304 may be used.

Referring to FIGS. 20 and 21, the pivot ring 322 is pivotally coupled to the pivot hub 311 and the pivot ring 323 is pivotally coupled to the pivot hub 312 such that the handle 304 is able to pivot with respect to the lower cooking assembly 302 about the pivot hubs 311 and 312. The pivot ring 322 and the pivot hub 311 together form the pivot arrangement 346 and the pivot ring 323 and the pivot hub 312 together form the pivot arrangement 347.

With the pivot ring 322 pivotally coupled to the pivot hub 311, the pivot ring 322 is disposed around the pivot shaft 314 such that the pivot shaft 314 extends through the pivot ring 322. The biasing means or compression spring 327 is disposed over and around the pivot shaft 314 such that a first end 343 of the biasing means engages the pivot base 313. The locking engagement element 328 is disposed on the pivot shaft 314 such that the pivot shaft 314 is received through the aperture 338 of the locking engagement element 328. The locking engagement element 328 is disposed on the pivot shaft 314 such that the first side 332 of the locking engagement element 328 engages a second end 344 of the biasing means 327 and handle engagement structure 331 faces the locking engagement structure 334.

As the profile of the aperture 338 of the locking engagement element 328 complements the profile of the pivot shaft 314, when the locking engagement element 328 is disposed on the pivot shaft 314, the locking engagement element 328 is able to move axially along pivot shaft axis 318 of the pivot shaft 314 but is restricted/prevented from rotating about the pivot shaft axis 318 of the pivot shaft 314. Accordingly, the aperture of the locking engagement element 328 and the profile of the pivot shaft 314 cooperate to restrict/prevent the locking engagement element 328 from rotating about the pivot shaft axis 318 of the pivot shaft 314.

The locking component 329 is disposed such that the pivot stub 316 is received by the aperture 340 of the locking component 329 and the locking component 329 abuts the pivot stop surface 115. The locking component 329 is able to partially rotate about the pivot shaft axis 318 of the pivot shaft 314. The locking component 329 is able to rotate in the anticlockwise direction until the first stop 341 of the locking component 329 engages the first axial surface 320 of the axial protrusion 319. The locking component 329 is able to rotate in the clockwise direction until the second stop 342 of the locking component 329 engages the second axial surface 321 of the axial protrusion 319.

The biasing means 327 engages the pivot base 313 and the first side 332 of the locking engagement element 328 to maintain each cam follower profile 335 of the locking engagement element 328 in engagement with one of the cams 339 of the locking component 329. The biasing means 327 therefore applies a force on the locking engagement element 328 in the direction generally indicated by arrow 30 (see FIG. 20).

The locking adjustment member or lever 330 is coupled to the locking component 329 such that the locking component 329 cannot rotate with respect to the locking adjustment member 330. The locking adjustment member 330 is pivotally coupled to the pivot shaft 314 by a fastener 345 extending through the locking adjustment member 330, through the locking component 329, and pivotally engaging the pivot aperture 317. When the locking adjustment member 330 is pivotally coupled to the pivot shaft 314, the locking adjustment member 330 retains the locking component 329 abutting against the pivot stop surface 315 and the locking component 329 retains the locking engagement element 328 and the biasing means 327 on the pivot shaft 314.

The locking adjustment member 330 is able to partially rotate about the pivot shaft axis 318 of the pivot shaft 314. As the locking adjustment member 330 is coupled to the locking component 329 such the that locking component 329 cannot rotate with respect to the locking adjustment member 330, rotation of the locking adjustment member 330 about the pivot shaft axis 318 of the pivot shaft 314 is limited by the locking component 358. In other words, the locking adjustment member 330 is able to rotate in the anticlockwise direction until the first stop 341 of the locking component 329 engages the first axial surface 320 of the axial protrusion 319. The locking adjustment member 330 is able to rotate in the clockwise direction until the second stop 342 of the locking component 329 engages the second axial surface 321 of the axial protrusion 319.

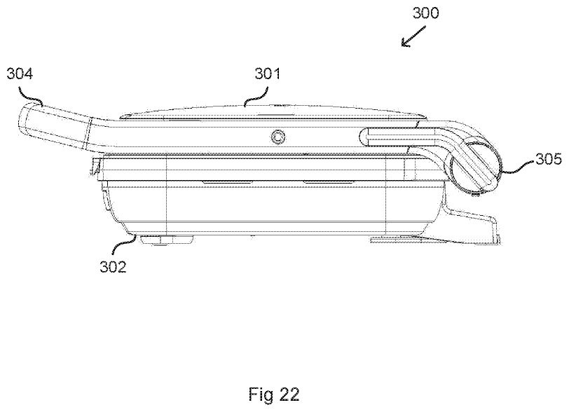

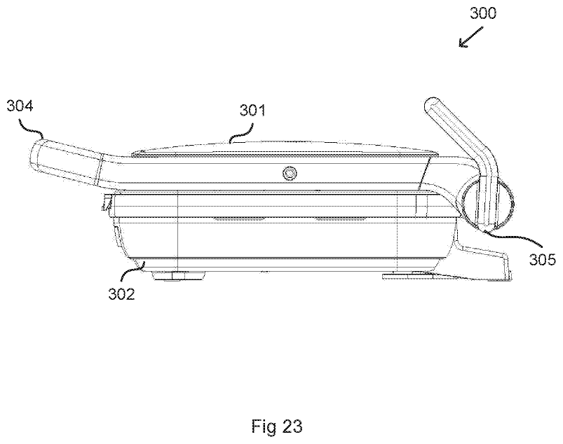

The locking assembly 305 is in an unlocked configuration when the locking adjustment member 330 is in an unlocked position (see FIG. 23) where the second stop 342 of the locking component 358 engages the second axial surface 321 of the axial protrusion 319. The locking assembly 305 is in a locked configuration when the locking adjustment member 330 is in a locked position (see FIG. 22) where the first stop 341 of the locking component 358 engages the first axial surface 320 of the axial protrusion 319. The locking assembly 305 is therefore movable between the locked and unlocked configurations by rotating the locking adjustment member 330 between the locked and unlocked positions about the pivot shaft axis 318, respectively.

As the complementary profiles of the pivot shaft 314 and the aperture 338 of the locking engagement element 328 cooperate to restrict/prevent the locking engagement element 328 from rotating about the pivot shaft axis 318 of the pivot shaft 114, rotating the locking adjustment member 330 to move the locking assembly 305 between the locked and unlocked configurations causes relative rotational movement between the locking component 329 and the locking engagement element 328. Further, as the biasing means 328 maintains each cam follower profile 335 in engagement with one of the cams 339, rotating the locking adjustment member 330 to move the locking assembly 305 between the locked and unlocked configurations causes each cam 339 to slide along a respective one of the cam follower profiles 335.

When the locking assembly 305 is in the unlocked configuration, each cam 339 of the locking component 329 is received in one of the cam seats 336 of the locking engagement element 328. In this configuration, the biasing means 327 urges the locking engagement element 328 axially along the pivot shaft 314 away from the handle engagement element 326 such that the locking engagement structure 334 is disengaged from the handle engagement structure 331.

Moving the locking assembly 305 from the unlocked configuration to the locked configuration causes each cam 339 to slide out of the corresponding cam seat 336 and onto the corresponding cam ridge 337. As the locking component 329 cannot move axially along the pivot shaft axis 318 of the pivot shaft 314, sliding the cams 339 out of the cam seats 336 and onto the cam ridges 337 causes the locking component 329 to move the locking engagement element 328 axially along the pivot shaft axis 318 of the pivot shaft 314 towards the handle engagement element 326 by compressing the biasing means 327 in a direction generally indicated by arrow 32. When the locking assembly 305 is in the locked configuration, the locking engagement structure 334 of the locking engagement element 328 is engaged with handle engagement structure 331 of the handle engagement element 326 via an interference fit. As the locking engagement element 328 is restricted/prevented from rotating about the pivot shaft axis 318 of the pivot shaft 314, the engagement between the locking engagement structure 334 and the handle engagement structure 331 restricts/prevents the handle 304 from rotating with respect to the lower cooking assembly 302 about the pivot arrangement 346. Accordingly, the locking assembly 305 acts on the pivot arrangement 346 when the locking assembly 305 is in the locked configuration.

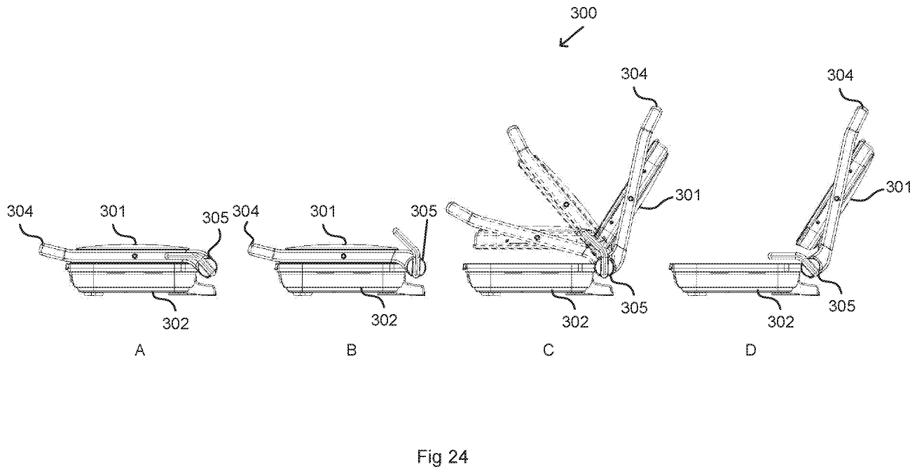

When the locking assembly 305 is in the unlocked configuration, the locking engagement structure 334 and the handle engagement structure 331 are disengaged from each other and the handle 304 is able to be rotated about the pivot arrangements or assemblies 346 and 347 to move the cooking appliance 300 between the open and closed positions. Referring to FIG. 24, when locking assembly 305 is in the unlocked configuration and the cooking appliance 300 is in the closed position (see FIG. 24B), lifting the handle 304 upwards will cause the handle 304 to rotate about the pivot hubs 311 and 312, which will separate the upper cooking assembly 301 from the lower cooking assembly 302. This will allow a user to place food between the upper cooking plate 307 and the lower cooking plate 309. Lowering the handle 304 will move the upper cooking assembly 301 toward the lower cooking assembly 302 so that any food placed on the lower cooking plate 309 will be sandwiched between the upper cooking plate 307 and the lower cooking plate 309 so that the upper cooking plate 307 operates as a contact grill.

As the upper cooking assembly 301 is pivotally coupled to the handle 304 by the pivots 311 and 312, the upper cooking assembly 301 is able to rotate with respect to the handle 304 as the handle 304 is rotated about the pivot arrangements 346 and 347 to move the cooking appliance 300 between the open and closed positions. Accordingly, when the upper cooking plate 307 of the upper cooking assembly 301 is brought into contact with food place on the lower cooking plate 309, the upper cooking plate 307 can rotate with respect to the handle 304 such that contact between the upper cooking plate 307 and the food may be maximised. Once the upper cooking plate 307 is at a position where it is in contact with the food disposed on the lower cooking plate 309, a user can rotate the locking adjustment member 330 to move the locking assembly 305 from the unlocked configuration to the locked configuration, thereby releasably retaining the upper cooking assembly 301 at that position via the engagement of the handle engagement structure 331 and the locking engagement structure 334.

Referring to FIG. 24C, for a predetermined range of rotation of the handle 304 with respect to the lower cooking assembly 302, the upper cooking assembly 302 is able to rotate with respect to handle 304 as the handle 304 is rotated to move the cooking appliance 300 between the open and closed positions such that the upper cooking plate 307 remains facing the lower cooking plate 309 while the handle 304 is being rotated through this range. Accordingly, the locking assembly 305 is able to releasbly retain the upper cooking assembly 301 at a plurality of distances or positions with respect to the lower cooking plate 309 by engaging the locking engagement structure 334 and the handle engagement structure 331 and different relative angular positions with respect to each other.

The width of the serrations of the handle engagement structure 331 and the locking engagement structure 334 determines the number of distances or positions at which the upper cooking assembly 301 may be retained with respect to the lower cooking assembly 302. Increasing the width of the serrations decreases the number of distances or positions, while decreasing the width of the serrations increases the number of distances or positions. Accordingly, the serrations of the handle engagement structure 331 and the locking engagement structure 334 may allow the upper cooking assembly 301 to be retained at more distances or positions with respect to the lower cooking assembly 302 compared to the prior art cooking appliances.

Although the handle engagement structure 331 and the locking engagement structure 334 have been described an illustrated as a plurality of serrations, it is envisaged that other interference fit structures with varying profiles defining different numbers of discreet positions may be used to restrict/prevent the handle 304 from rotating with respect to the lower cooking assembly 302 about the pivot hubs 311 and 312.

It is also that the handle engagement element 326 and the locking engagement element 328 may not include the handle engagement structure 331 and the locking engagement structure 334, respectively. Instead, the handle engagement element 326 may engage the locking engagement element 328 via friction. In this case, the surfaces of the handle engagement element 326 and the locking engagement element 328 that are configured to engage with each other may have a high coefficient of friction.

Further, although the pivot hubs 311 and 312 have been described and illustrated as being part of the lower cooking plate 309, it is also envisaged that the lower housing 308 of the lower cooking assembly 302 could instead comprises the pivot hubs 311 and 312.

It is also envisaged that the cams 339 of the locking component 329 may be integral with the locking adjustment member 330.

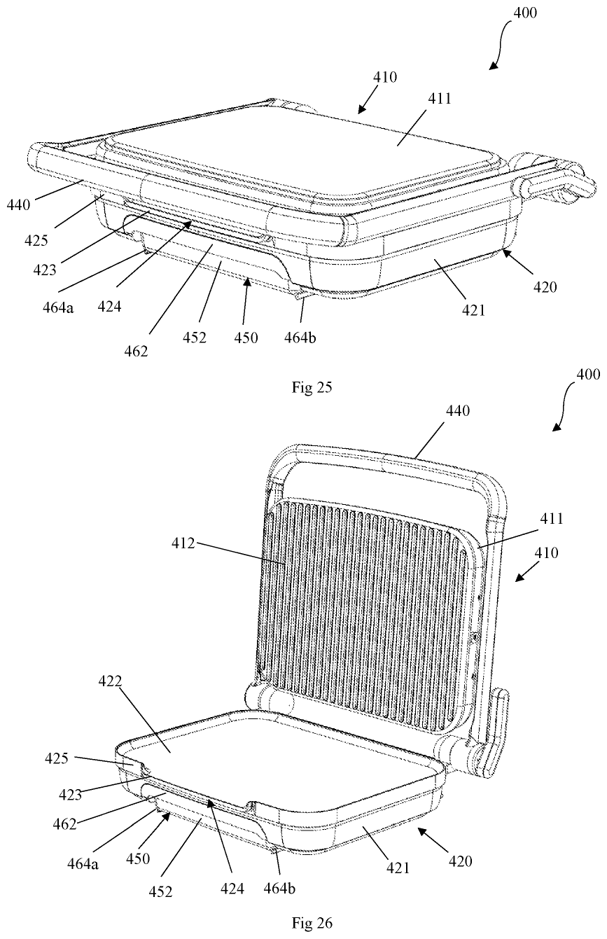

FIGS. 25 and 26 show a cooking appliance 400 according to a fourth embodiment in the form of a sandwich press and/or grill in a closed and open position, respectively. The cooking appliance 400 has an upper cooking assembly 410, a lower cooking assembly 420, a handle 440, and a drip tray 450.

The upper cooking assembly 410 has an upper housing 411 and an upper cooking plate 412 accommodated in the upper housing 411. The lower cooking assembly 420 has a lower housing 421 and a lower cooking plate 422 accommodated in the lower housing 421. The upper cooking plate 412 faces the lower cooking plate 422 when the cooking appliance 400 is in a closed position (see FIG. 25). The upper cooking assembly 410 is pivotally coupled to the handle 440, which is pivotally coupled to the lower cooking assembly 420.

Referring to FIG. 26, lifting the handle 440 upwards will separate the upper cooking assembly 410 from the lower cooking assembly 420, which will allow a user to place food between the upper cooking plate 412 and the lower cooking plate 422. Lowering the handle 440 will move the upper cooking assembly 410 toward the lower cooking assembly 420 so that any food placed on the lower cooking plate 422 will be sandwiched between the upper cooking plate 412 and the lower cooking plate 422 so that the upper cooking plate 412 operates as a contact grill. In one “fry” mode of operation, the upper cooking assembly 410 is left opened completely so that food may be fried on the lower cooking plate 422.

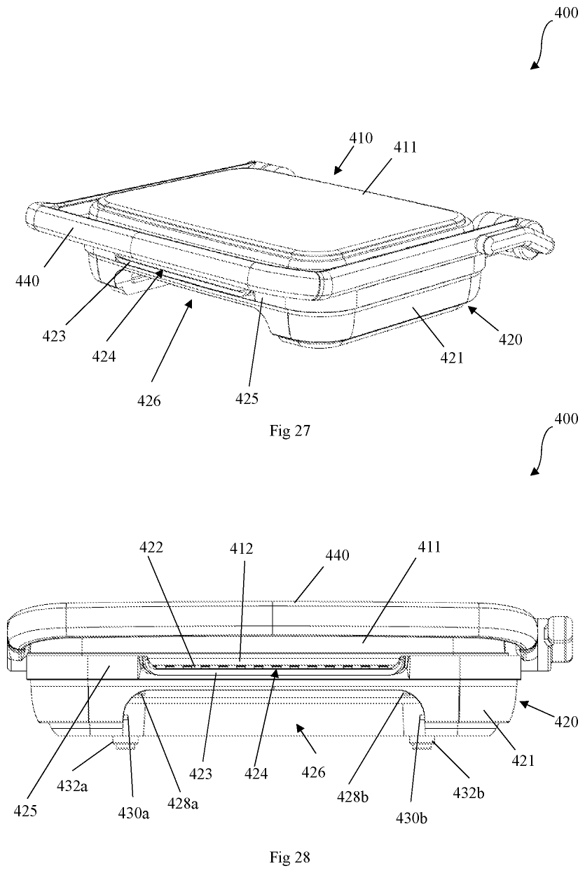

The lower cooking assembly 420 has an overhanging lip 423 defining an opening 424 in a front edge 425 of the lower cooking assembly 420. The opening 424 is in fluid communication with the lower cooking plate 422 to allow fluid to be drained through the opening 424 and into the drip tray 450. Referring to FIGS. 27 to 29, the lower housing 421 also defines a void 426 for removably receiving the drip tray 450.

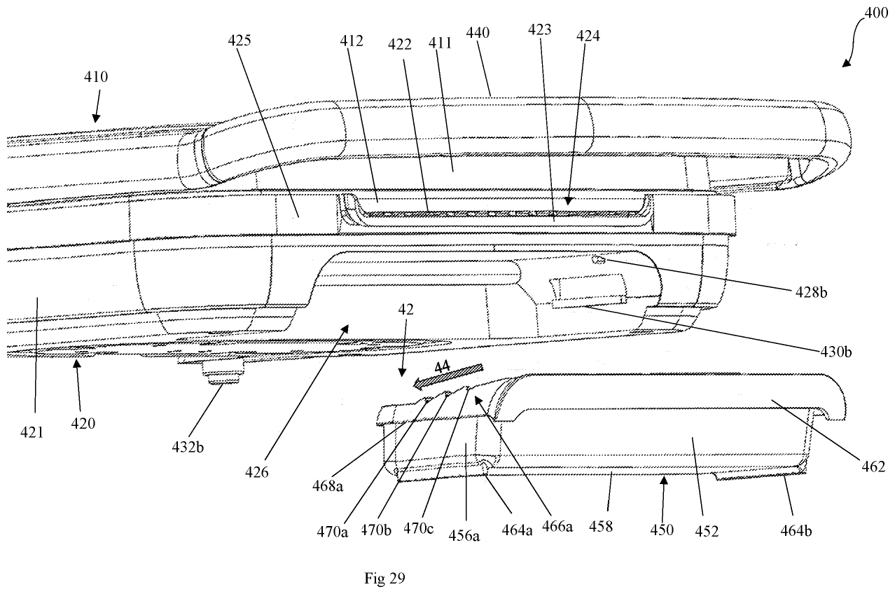

Referring to FIGS. 28 and 29, the lower housing 421 has a pair of corresponding tilting formations 428a and 428b in the form of protrusions. The tilting formations 428a and 428b are disposed in and protrude into the void 426. The lower housing 421 also has a pair of corresponding ledges 430a and 430b disposed in and projecting into the void 426.

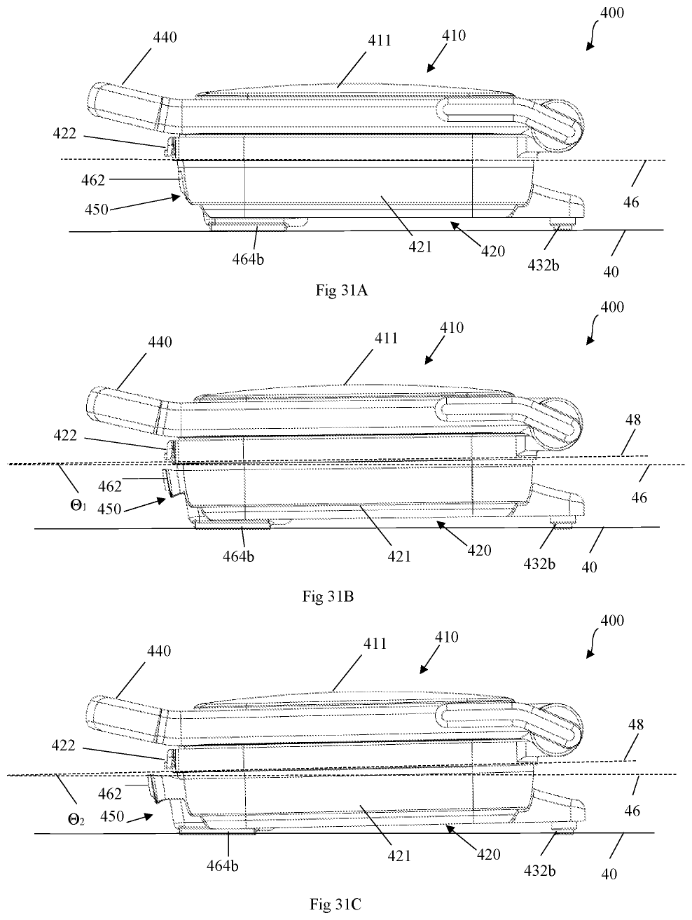

In use, the lower cooking assembly 420 will be disposed on a surface 40 (see FIGS. 31A-C). The lower housing 421 has a pair of feet 432a and 432b, which engage the surface 40 on which the lower cooking assembly 420 is disposed to at least partially support the lower cooking assembly 420 on the surface 40.

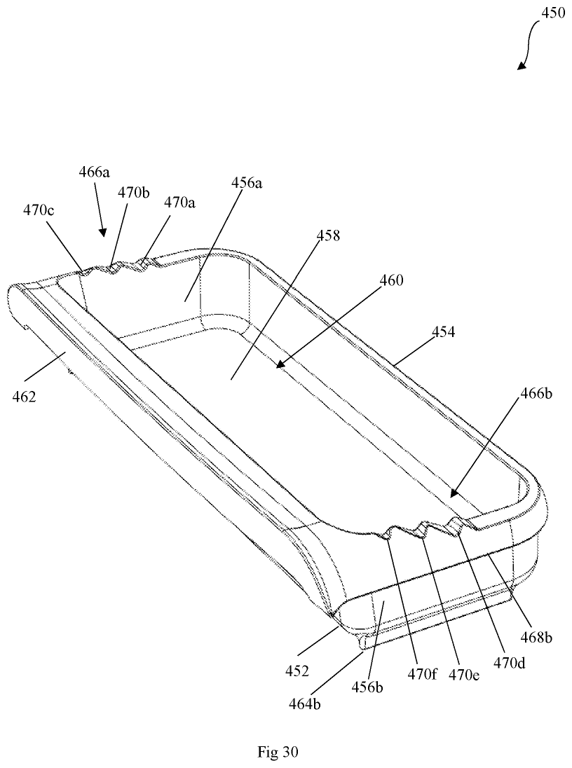

Referring to FIGS. 29 and 30, the drip tray 450 has a front wall 452, a rear wall 454, a pair of sidewalls 456a and 456b, and a base 458. Together, the front wall 452, the rear wall 454, the sidewalls 456a and 456b, and the base 458 define a drip tray volume 460. The drip tray 450 also has a handle 462 and a pair of feet 464a and 464b. The feet 464a and 464b are configured to engage a surface 40 on which the cooking appliance 400 is disposed.

Sidewall 456a defines a cooperating tilting formation 466a and a lip 468a. Similarly, sidewall 456b defines a cooperating tilting formation 466b and a lip 468b. The cooperating tilting formations 466a and 466b are each in the form of drip tray adjustment profiles that taper from the front wall 452 to the rear wall 454.

Cooperating tilting formation 466a defines a plurality of seats 470a-c and cooperating tilting formation 466b defines a plurality of seats 470d-f. Each seat 470a-c is configured to receive the tilting formation 428a and each seat 470d-f is configured to receive the tilting formation 428b.

Seats 470a and 470d correspond with each other and are disposed at substantially the same level above the feet 464a, 464b, seats 470b and 470e correspond with each other and are disposed at substantially the same level above the feet 464a, 464b, and seats 470c and 470f correspond with each other and are disposed at substantially the same level above the feet 464a, 464b. Seats 470c and 470f are disposed at a higher level compared to seats 470b and 470e, which are disposed at a higher level compared to seats 470a and 470d.

The drip tray 450 is configured to be removably receivable in the void 426 of the lower housing 421 by sliding the drip tray 450 into the void 426. The drip tray 450 is also configured to be removed from the void 426 by sliding the drip tray out of the void 426.

When the drip tray 450 is at least partially received in the void 426 of the lower housing 421, the feet 464a and 464b of the drip tray 450 engage the surface 40 on which the cooking appliance 400 is disposed (see FIGS. 31A-C) and the drip tray 450 supports the front portion of the lower cooking assembly 420 via the engagement between the tilting formations 428a, 428b and the cooperating tilting formations 466a, 466b, respectively.

The lips 468a and 468b of the drip tray 450 cooperate with the ledges 430a and 430b of the lower housing 421, respectively, to releasably couple the drip tray 450 to the lower housing 421. Accordingly, the lips 468a and 468b and the ledges 430a and 430b cooperate to prevent the drip tray 450 from falling out of the void 426 in the direction generally indicated by arrow 42 (see FIG. 29).

When the cooking appliance 400 is disposed on a surface 40 and the drip tray 450 is at least partially received in the void 426, the feet 432a and 432b of the lower cooking assembly 420 and the feet 464a and 464b of the drip tray 450 engage the surface 40 and support the lower cooking assembly 420. Further, when the drip tray 450 is at least partially received in the void 426, the drip tray volume 460 is disposed below the opening 424 and overhanging lip 423 of the lower cooking assembly 420.

Referring to FIG. 29, inserting the drip tray 450 into the void 426 of the lower housing 421 involves disposing the lips 468a and 468b of the drip tray 450 on the ledges 430a and 430b of the lower housing 421, respectively, and sliding the drip tray 450 into the void 426 in the general direction of arrow 44. Sliding the drip tray 450 into the void 426 will cause relative movement of the tilting formations 428a and 428b of the lower housing 421 over the cooperating tilting formations 466a and 466b of the drip tray 450, respectively. This relative movement causes the tilting formation 428a of the lower housing 421 to engage the cooperating tilting formation 466a of the drip tray 450 at a plurality of different positions along the cooperating tilting formation 466a. Similarly, this relative movement causes the tilting formation 428b of the lower housing 421 to engage the cooperating tilting formation 466b of the drip tray 450 at a plurality of different positions along the cooperating tilting formation 466b.

The tilting formations 428a and 428b of the lower housing 421 are configured to cooperate with the seats 470a-c and 470d-f of the tilting formations 466a and 466b respectively to retain the drip tray 450 in a particular position within the void 426 and with respect to the lower housing 421. When the tilting formations 428a and 428b are received in the seats 470a and 470d, respectively, the drip tray 450 is retained in a first position within the void 426 and with respect to the lower housing 421 (see FIG. 31A). When the tilting formations 428a and 428b are received in the seats 470b and 470e, respectively, the drip tray 450 is retained in a second position within the void 426 and with respect to the lower housing 421 (see FIG. 31B). When the tilting formations 428a and 428b are received in the seats 470c and 470f. respectively, the drip tray 450 is retained in a third position within the void 426 and with respect to the lower housing 421 (see FIG. 31C).

Referring to FIG. 29, removing the drip tray 450 from the void 426 involves sliding the drip tray 450 out of the void 426 in a direction opposite to the arrow 44. In this case, the relative movement of the tilting formations 428a and 428b of the lower housing 421 over the cooperating tilting formations 466a and 66b of the drip tray 1540, respectively, will be in the opposite direction compared to when the drip tray 450 is being inserted into the void 426.

FIG. 31A illustrates the cooking appliance 400 when the drip tray 450 is fully received in the void 426 and the handle 462 of the drip tray 450 is flush with the lower housing 421. In other words, FIG. 31A illustrates the drip tray 450 in a closed position relative to the lower housing 421. In this position, the tilting formations 428a and 428b of the lower housing 421 are received in the seats 470c and 470f of the drip tray 450, respectively.

When the drip tray 450 is in the closed position, the lower cooking plate 422 is at least substantially parallel with the surface 40 on which the cooking appliance 400 is disposed. In this position, little, if any, liquid (e.g. grease, oil, sauce, etc.) on the lower plate 422 will be directed to the opening 424 in the lower cooking appliance 420. The dashed line 46 in each of FIGS. 31A-C is parallel to the surface 40 and is there to illustrate the angle of the lower cooking plate 422 with respect to the surface 40.

FIGS. 31B and C each illustrate the drip tray 450 in an open position relative to the lower housing 421. FIG. 31B illustrates the cooking appliance 400 when the drip tray 450 is received in the void 426 and the tilting formations 428a and 428b of the lower housing 421 are received in the seats 470b and 470e of the drip tray 450, respectively. FIG. 31C illustrates the cooking appliance 400 when the drip tray 450 is received in the void 426 and the tilting formations 428a and 428b of the lower housing 421 are received in the seats 470a and 470d of the drip tray 450, respectively.

When the drip tray 450 is received in the void 426 such that tilting formation 428a is received in seat 470a and tilting formation 428b is received in seat 470d (see FIG. 31C), the drip tray 450 supports the front edge 425 of the lower cooking assembly 420 at a height above the surface 40 that is lower compared to when tilting formation 428a is received in seat 470b and tilting formation 428b is received in seat 470c. Accordingly, when tilting formation 428a is received in seat 470a and tilting formation 428b is received in seat 470d, the angle Θ₂ of the lower cooking plate 422 with respect to the surface 40 (see FIG. 31C) is greater than the angle Θ₁ of the lower cooking plate 422 with respect to the surface 40 (see FIG. 31B) when tilting formation 428a is received in seat 470b and tilting formation 428b is received in seat 470e. The dashed line 48 in each of FIGS. 31B and 31C illustrate the angle of the lower cooking plate 422 with respect to the surface 40.

When the drip tray 450 is received in the void 426 in either of the positions illustrated in FIGS. 31B and C, the lower cooking plate 422 is at an angle that is not parallel with respect to the surface 40. Further, in either of these positions, the drip tray volume 460 is disposed below the overhanging lip 423 of the lower housing 421 and positioned to collect any liquid flowing through and falling from the opening 424 in the lower cooking assembly 420. Accordingly, in these positions, when cooking food using the cooking appliance 400, liquid (e.g. grease, oil, sauce, etc.) on the lower cooking plate 422 will flow off the lower cooking plate 422 due to the angle of the lower cooking plate 422 with respect to the surface 40 and will be directed to flow through the opening 424. Liquid flowing through the opening 424 will fall from the overhanging lip 423 into, and be collected by, the drip tray volume 460.

As the cooperating tilting formations 466a and 466b taper from the front wall 452 to the rear wall 454, sliding the drip tray 450 further into the void 426 will cause the tilting formations 428a and 428b of the lower housing 421 to cooperate with the cooperating angle formations 466a and 466b of the drip tray 450 to increase the height above the surface 40 at which the front edge 425 of the lower cooking assembly 420 is supported and decrease the angle of the lower cooking plate 422 relative to the surface 40. Conversely, sliding the drip tray 450 out the void 426 will cause the tilting formations 428a and 428b of the lower housing 421 to cooperate with the cooperating tilting formations 466a and 466b of the drip tray 450 to decrease the height above the surface 40 at which the front edge 425 of the lower cooking assembly 420 is supported and increase the angle of the lower cooking plate 422 relative to the surface 40. Accordingly, the angle of the lower cooking plate 422 can be varied by moving the drip tray 450 further into and out of the void 426.

It is also envisaged that the cooperating tilting formations 466a and 466b could taper from the rear wall 454 to the front wall 452. In this case, the angle of the lower cooking plate 422 with respect to the surface 40 may be increased by sliding the drip tray 450 further into the void 426 and the angle of the lower cooking plate 422 with respect to the surface 40 may be decreased by sliding the drip tray 450 out of the void 426.

Accordingly, a user may adjust the angle of the lower cooking plate 422 with respect to the surface 40 by moving the drip tray 450 further into or out of the void 426. The user may, therefore, adjust the angle of the lower cooking plate 422 based on the food they are going to cook by moving the drip tray 450 with respect to the lower housing 421. If the user would like to increase the flow of liquid off the lower cooking plate 422, through the opening 424, and into the drip tray volume 460, the user may increase the angle of the lower cooking plate 422 with respect to surface 40 by moving the drip tray 450 further out of the void 426. Conversely, if the user would like to reduce the flow of liquid off the lower cooking plate 422, through the opening 424, and into the drip tray volume 460, the user may decrease the angle of the lower cooking plate 422 with respect to surface 40 by moving the drip tray 450 further into the void 426.

Although the cooperating tilting formations 466a and 466b have been described and illustrated as each having three seats 470a-c and 470 d-f, respectively, it is envisaged that the cooperating tilting formations 466a and 466b may include more or less seats, thereby allowing the lower cooking plate 422 plate to be positioned at more or less angles with respect to the surface 40, respectively.

Further, although the cooperating tilting formations 466a and 466b of the drip tray 450 have been described and illustrated as having distinct seats 470a-c and 470d-f, it will be appreciated that the cooperating tilting formations 466a and 466b may taper from front wall 452 to the rear wall 454 in a continuous manner. In this case, the tilting formations 428a and 428b of the lower housing 421 may be configured to frictionally engage the cooperating tilting formations 466a and 466b, respectively, to retain the drip tray 450 at a desired position within the void 426 and with respect to the lower housing 421.

Although the tilting formations 428a and 428b of the lower housing 421 have been illustrated as protrusions and the cooperating tilting formations 466a and 466b of the drip tray 450 have been illustrated as drip tray adjustment profiles, it is envisaged that the tilting formations 428a and 428b of the lower housing 421 may be in the form of housing adjustment profiles similar to the drip tray adjustment profiles illustrated in FIGS. 29 and 30 and the cooperating tilting formations 466a and 466b of the drip tray 450 may be in the form of drip tray protrusions similar to the housing protrusions illustrated in FIGS. 28 and 29.

It is also envisaged that both the tilting formations 428a and 428b of the lower housing 421 and the cooperating tilting formations 466a and 466b of the drip tray 450 may be complementary profiles configured to engage each other, respectively, and vary the angle of the lower cooking plate 422 with respect to the surface 40 on which the cooking appliance 400 is disposed by moving the drip tray 450 with respect to the lower housing 421.

It is envisaged that the cooking appliance 400 could include the locking assembly 105 of the cooking appliance 100, the locking assembly 252 of the cooking appliance 200, or the locking assembly 305 of the cooking appliance 300.

It will be understood that the invention disclosed and defined in this specification extends to all alternative combinations of two or more of the individual features mentioned or evident from the text or drawings. All of these different combinations constitute various alternative aspects of the invention.

Reference to any prior art in the specification is not an acknowledgment or suggestion that this prior art forms part of the common general knowledge in any jurisdiction or that this prior art could reasonably be expected to be understood, regarded as relevant, and/or combined with other pieces of prior art by a skilled person in the art.

By way of clarification and for avoidance of doubt, as used herein and except where the context requires otherwise, the term “comprise” and variations of the term, such as “comprising”, “comprises” and “comprised”, are not intended to exclude further additions. components, integers or steps.

1. A cooking appliance comprising:
a lower cooking assembly carrying a lower cooking plate;
a handle pivotally coupled to the lower cooking assembly about a first pivot arrangement; an upper cooking assembly pivotally coupled to the handle about a second pivot arrangement, the upper cooking assembly carrying an upper cooking plate; and
a locking assembly configured to engage the first pivot arrangement, the locking assembly movable between a locked configuration in which the locking assembly is engaged with the first pivot arrangement and an unlocked configuration in which the locking assembly is disengaged from the first pivot arrangement,
wherein:
in the unlocked configuration, the handle is able to rotate about the first pivot arrangement to vary a position of the upper cooking assembly with respect to the lower cooking assembly; and
in the locked configuration, rotation of the handle about the first pivot arrangement is restricted, thereby releasably retaining the upper cooking assembly at one of a plurality of positions with respect to the lower cooking assembly.

2. The cooking appliance of claim 1, wherein:
the locking assembly has a first engagement element connected to the handle and a second engagement element;
in the unlocked configuration, the first and second engagement elements are disengaged from each other, thereby allowing the handle to rotate about the first pivot arrangement; and
in the locked configuration, the first and second engagement elements are engaged with each other, the engagement of the first and second engagement elements restricting rotation of the handle about the first pivot arrangement.

3. The cooking appliance of claim 2, wherein:
the first pivot arrangement comprises a pivot connected to the lower cooking assembly and a pivot ring connected to the handle;
the pivot ring is pivotally coupled to the pivot and configured to rotate about the pivot; and
the first engagement element is disposed around the pivot ring.

4. The cooking appliance of claim 3, wherein:
the pivot has a pivot shaft defining a pivot shaft axis;
in response to moving the locking assembly from the locked configuration to the unlocked configuration, the second engagement element moves away from the first engagement element along the pivot shaft axis to disengage from the first engagement element; and
in response to moving the locking assembly from the unlocked configuration to the locked configuration, the second engagement element moves towards the first engagement element along the pivot shaft axis to engage the first engagement element.

5. The cooking appliance of claim 4, wherein:
the pivot has an annular track around the pivot shaft;
the pivot ring has an annular protrusion disposed in the annular track; and
the annular protrusion and the annular track cooperate to define rotational movement of the pivot ring about the pivot shaft.

6. The cooking appliance of claim 4, wherein the pivot ring defines an aperture disposed around the pivot shaft.

7. The cooking application of claim 6, wherein the first pivot arrangement further comprises a handle coupling element disposed within the aperture of the pivot ring to pivotally coupled the handle to the pivot.

8. The cooking appliance of claim 7, wherein:
the pivot ring has an annular ledge within the aperture; and
the handle coupling element engages the annular ledge and is coupled to the pivot.

9. The cooking appliance of claim 8, wherein the annular ledge and the annular protrusion are disposed between the pivot and the handle coupling element.

10. The cooking appliance of claim 7, wherein the second engagement element is disposed on the handle coupling element.

11. The cooking appliance of claim 2, wherein the locking assembly further comprises a biasing element configured to bias the second engagement element away from the first engagement element when the locking assembly is in the unlocked configuration.

12. The cooking appliance of claim 7, wherein the locking assembly further comprises a biasing element disposed on the handle coupling element, the biasing element configured to bias the second engagement element away from the first engagement element when the locking assembly is in the unlocked configuration.

13. The cooking appliance of claim 12, wherein the biasing element contacts the handle coupling element and the second engagement element.

14. The cooking appliance of claim 7, wherein the locking assembly further comprises a locking adjustment member configured to move the locking assembly between the locked and unlocked configurations.

15. The cooking appliance of claim 14, wherein:
the locking adjustment member has at least one cam;
the second engagement element has at least one cam follower profile engaged with the at least one cam; and
the at least one cam and the at least one cam follower profile cooperate with each other to engage and disengage the second engagement element with the first engagement element when moving the locking assembly between the locked and unlocked configurations.

16. The cooking appliance of claim 14, wherein the locking adjustment member and handle coupling element cooperate with each other to limit movement of the locking adjustment member between a locked position in which the locking assembly is in the locked configuration and an unlocked position in which the locking assembly is in the unlocked configuration.

17. The cooking appliance of claim 16, wherein the locking adjustment member is movable between the locked and unlocked positions by rotating the locking adjustment member about the pivot shaft axis.

18. The cooking appliance of claim 14, wherein the locking adjustment member is a lever.

19. The cooking appliance of claim 2, wherein:
the first engagement element has an engagement structure;
the second engagement element has an engagement structure;
in the locked position, the engagement structures of the first and second engagement elements are engaged with each other to restrict rotation of the handle about the first pivot arrangement; and
in the unlocked position, the engagement structures of the first and second engagement elements are disengaged from each other, thereby allowing the handle to rotate about first pivot arrangement.

20. The cooking appliance of claim 19, wherein the first engagement structure and second engagement structure engage in an interference fit.

21. The cooking appliance of claim 1, wherein the cooking appliance is a sandwich press or grill.
